(19) United States
(12) Patent Application Publication
(10) Pub. No.: US 2025/0267726 A1
(43) Pub. Date: Aug. 21, 2025

(54) PHYSICAL UPLINK SHARED CHANNEL OCCASION VALIDATION

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Ahmed Attia ABOTABL, San Diego, CA (US)

(21) Appl. No.: 19/018,175

(22) Filed: Jan. 13, 2025

Related U.S. Application Data
(60) Provisional application No. 63/555,062, filed on Feb. 18, 2024.

(51) Int. Cl. H04W 74/0836; H04L 5/14

(52) U.S. Cl. CPC H04W 74/0836; H04L 5/14

(57) ABSTRACT

A user equipment (UE) may transmit uplink shared channel message via a valid physical uplink shared channel occasion (PO), where the validity of the PO may be based on one or more rules associated with a sub-band full-duplex (SBFD) configuration. The UE may receive the SBFD configuration and a message indicating one or more POs. The one or more rules may indicate that a PO is valid based on whether the PO is in an uplink sub-band of an SBFD slot, whether the PO is in an uplink or flexible slot, whether the resources of the PO overlap with resources for another PO or RO, a location of the PO relative to a synchronization signal block (SSB) or a physical broadcast channel (PBCH) block or a downlink symbol, or any combination thereof. In some cases, the POs may be SBFD-dedicated POs.

### CROSS-REFERENCE TO RELATED APPLICATIONS

This patent application claims priority to U.S. Provisional Patent Application No. 63/555,062 entitled “PHYSICAL UPLINK SHARED CHANNEL OCCASION VALIDATION” and filed on Feb. 18, 2024, which is assigned to the assignee hereof. The disclosures of all prior applications are considered part of and are incorporated by reference in this patent application.

### FIELD OF TECHNOLOGY

The following relates generally to wireless communication, including physical uplink shared channel occasion validation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support physical uplink shared channel (PUSCH) occasion validation. For example, the described techniques enable a user equipment (UE) to receive a sub-band full-duplex (SBFD) configuration and a message indicating one or more PUSCH occasions (POs) (e.g., where one or more of the POs identified by the message may be in one or more SBFD slots, or may be SBFD-dedicated POs). The UE may transmit a PUSCH portion of a random access (RA) message via a valid PO of the one or more POs, where the validity of the PO may be based on one or more rules associated with the SBFD configuration. For example, the one or more rules may indicate that a PO is valid based on whether the PO is in an uplink sub-band (UL-SB) of an SBFD slot, whether the PO is in an uplink or flexible slot, whether the resources of the PO overlap with resources for another PO or RO, a location of the PO relative to a synchronization signal block (SSB) or a physical broadcast channel (PBCH) block or a downlink symbol, or any combination thereof. In some cases, the POs may include SBFD-dedicated POs (e.g., POs dedicated to UEs with SBFD capabilities), non-SBFD-dedicated POs, or both.

A method for wireless communications by a UE is described. The method may include receiving a SBFD configuration for the UE, the SBFD configuration indicating one or more slots configured for SBFD operations, receiving a message indicating one or more POs for the UE, where at least one PO of the one or more POs is within a slot of the one or more slots configured for SBFD operations, and transmitting, via an PO of the one or more POs based on a validity of the PO, an uplink shared channel message including at least a portion of a first RA message associated with a two-step RACH procedure, where the validity of the PO is based on one or more rules associated with the SBFD configuration.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive a SBFD configuration for the UE, the SBFD configuration indicating one or more slots configured for SBFD operations, receive a message indicating one or more POs for the UE, where at least one PO of the one or more POs is within a slot of the one or more slots configured for SBFD operations, and transmit, via an PO of the one or more POs based on a validity of the PO, an uplink shared channel message including at least a portion of a first RA message associated with a two-step RACH procedure, where the validity of the PO is based on one or more rules associated with the SBFD configuration.

Another UE for wireless communications is described. The UE may include means for receiving a SBFD configuration for the UE, the SBFD configuration indicating one or more slots configured for SBFD operations, means for receiving a message indicating one or more POs for the UE, where at least one PO of the one or more POs is within a slot of the one or more slots configured for SBFD operations, and means for transmitting, via an PO of the one or more POs based on a validity of the PO, an uplink shared channel message including at least a portion of a first RA message associated with a two-step RACH procedure, where the validity of the PO is based on one or more rules associated with the SBFD configuration.

A non-transitory computer-readable medium storing code for wireless communications is described. The code may include instructions executable by at least one processor (e.g., directly, indirectly, after pre-processing, without pre-processing) to receive a SBFD configuration for the UE, the SBFD configuration indicating one or more slots configured for SBFD operations, receive a message indicating one or more POs for the UE, where at least one PO of the one or more POs is within a slot of the one or more slots configured for SBFD operations, and transmit, via an PO of the one or more POs based on a validity of the PO, an uplink shared channel message including at least a portion of a first RA message associated with a two-step RACH procedure, where the validity of the PO is based on one or more rules associated with the SBFD configuration.

In some examples of the method, UEs, and non-transitory computer-readable medium described herein, transmitting the uplink shared channel message may include operations, features, means, or instructions for transmitting the uplink shared channel message via an UL-SB of the slot according to the one or more rules, where the one or more rules indicate that the PO may be valid based on the PO being within the UL-SB of a SBFD symbol in the slot.

Some examples of the method, UEs, and non-transitory computer-readable medium described herein may further include operations, features, means, or instructions for receiving a TDD configuration for the UE, the TDD configuration indicating a slot format of the slot, where the one or more rules indicate that the PO may be valid based on the slot format of the slot including a downlink slot format or a flexible slot format according to the TDD configuration.

Some examples of the method, UEs, and non-transitory computer-readable medium described herein may further include operations, features, means, or instructions for receiving a TDD configuration for the UE, the TDD configuration indicating a slot format of the slot, where the one or more rules indicate that the PO may be valid based on the slot format of the slot including an uplink slot format or a flexible slot format according to the TDD configuration.

In some examples of the method, UEs, and non-transitory computer-readable medium described herein, transmitting the uplink shared channel message may include operations, features, means, or instructions for transmitting the uplink shared channel message via the slot according to the one or more rules, where the one or more rules indicate that the PO may be valid based on a slot format of the slot including a flexible slot format.

In some examples of the method, UEs, and non-transitory computer-readable medium described herein, transmitting the uplink shared channel message may include operations, features, means, or instructions for transmitting the uplink shared channel message according to the one or more rules, where the one or more rules indicate that the PO may be valid based on one or more frequency resources associated with the PO being different from one or more second frequency resources associated with one or more second POs that overlap in time resources in at least one symbol with the PO.

In some examples of the method, UEs, and non-transitory computer-readable medium described herein, transmitting the uplink shared channel message may include operations, features, means, or instructions for transmitting the uplink shared channel message according to the one or more rules, where the one or more rules indicate that the PO may be valid based on one or more time resources associated with the PO being different from one or more second time resources associated with one or more second POs.

In some examples of the method, UEs, and non-transitory computer-readable medium described herein, transmitting the uplink shared channel message may include operations, features, means, or instructions for transmitting the uplink shared channel message according to the one or more rules, where the one or more rules indicate that the PO may be valid based on a first set of time-frequency resources associated with the PO being different from a second set of time-frequency resources associated with one or more ROs.

In some examples of the method, UEs, and non-transitory computer-readable medium described herein, the one or more ROs may be associated with the two-step RACH procedure, a four-step RACH procedure, or both.

In some examples of the method, UEs, and non-transitory computer-readable medium described herein, the one or more ROs may be associated with the SBFD configuration, a TDD configuration, or both.

In some examples of the method, UEs, and non-transitory computer-readable medium described herein, the one or more POs include POs dedicated for SBFD operations.

In some examples of the method, UEs, and non-transitory computer-readable medium described herein, the one or more POs include POs associated with SBFD operations and POs associated with TDD operations.

In some examples of the method, UEs, and non-transitory computer-readable medium described herein, transmitting the uplink shared channel message may include operations, features, means, or instructions for transmitting the uplink shared channel message according to the one or more rules, where the one or more rules indicate that the PO may be valid based on the PO beginning at least a first threshold quantity of symbols after a first BBB or a first broadcast channel message (e.g., PBCH block) and beginning a second threshold quantity of symbols before a second BBB or a second broadcast channel message.

In some examples of the method, UEs, and non-transitory computer-readable medium described herein, transmitting the uplink shared channel message may include operations, features, means, or instructions for transmitting the uplink shared channel message according to the one or more rules, where the one or more rules indicate that the PO may be valid based on the PO beginning at least a threshold quantity of symbols after a previous downlink symbol.

A method for wireless communications by a network entity is described. The method may include outputting a SBFD configuration for a UE, the SBFD configuration indicating one or more slots configured for SBFD operations, outputting a message indicating one or more POs for the UE, where at least one PO of the one or more POs is within a slot of the one or more slots configured for SBFD operations, and obtaining, via an PO of the one or more POs based on a validity of the PO, an uplink shared channel message including at least a portion of a first RA message associated with a two-step RACH procedure, where the validity of the PO is based on one or more rules associated with the SBFD configuration.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the network entity to output a SBFD configuration for a UE, the SBFD configuration indicating one or more slots configured for SBFD operations, output a message indicating one or more POs for the UE, where at least one PO of the one or more POs is within a slot of the one or more slots configured for SBFD operations, and obtain, via an PO of the one or more POs based on a validity of the PO, an uplink shared channel message including at least a portion of a first RA message associated with a two-step RACH procedure, where the validity of the PO is based on one or more rules associated with the SBFD configuration.

Another network entity for wireless communications is described. The network entity may include means for outputting a SBFD configuration for a UE, the SBFD configuration indicating one or more slots configured for SBFD operations, means for outputting a message indicating one or more POs for the UE, where at least one PO of the one or more POs is within a slot of the one or more slots configured for SBFD operations, and means for obtaining, via an PO of the one or more POs based on a validity of the PO, an uplink shared channel message including at least a portion of a first RA message associated with a two-step RACH procedure, where the validity of the PO is based on one or more rules associated with the SBFD configuration.

A non-transitory computer-readable medium storing code for wireless communications is described. The code may include instructions executable by at least one processor (e.g., directly, indirectly, after pre-processing, without pre-processing) to output a SBFD configuration for a UE, the SBFD configuration indicating one or more slots configured for SBFD operations, output a message indicating one or more POs for the UE, where at least one PO of the one or more POs is within a slot of the one or more slots configured for SBFD operations, and obtain, via an PO of the one or more POs based on a validity of the PO, an uplink shared channel message including at least a portion of a first RA message associated with a two-step RACH procedure, where the validity of the PO is based on one or more rules associated with the SBFD configuration.

In some examples of the method, network entities, and non-transitory computer-readable medium described herein, obtaining the uplink shared channel message may include operations, features, means, or instructions for obtaining the uplink shared channel message via an UL-SB of the slot according to the one or more rules, where the one or more rules indicate that the PO may be valid based on the PO being within the UL-SB of a SBFD symbol on the slot.

Some examples of the method, network entities, and non-transitory computer-readable medium described herein may further include operations, features, means, or instructions for outputting a TDD configuration to the UE, the TDD configuration indicating a slot format of the slot, where the one or more rules indicate that the PO may be valid based on the slot format of the slot including a downlink slot format or a flexible slot format according to the TDD configuration.

Some examples of the method, network entities, and non-transitory computer-readable medium described herein may further include operations, features, means, or instructions for outputting a TDD configuration to the UE, the TDD configuration indicating a slot format of the slot, where the one or more rules indicate that the PO may be valid based on the slot format of the slot including an uplink slot format or a flexible slot format according to the TDD configuration.

In some examples of the method, network entities, and non-transitory computer-readable medium described herein, obtaining the uplink shared channel message may include operations, features, means, or instructions for obtaining the uplink shared channel message via the slot according to the one or more rules, where the one or more rules indicate that the PO may be valid based on a slot format of the slot including a flexible slot format.

In some examples of the method, network entities, and non-transitory computer-readable medium described herein, obtaining the uplink shared channel message may include operations, features, means, or instructions for obtaining the uplink shared channel message according to the one or more rules, where the one or more rules indicate that the PO may be valid based on one or more frequency resources associated with the PO being different from one or more second frequency resources associated with one or more second POs.

In some examples of the method, network entities, and non-transitory computer-readable medium described herein, obtaining the uplink shared channel message may include operations, features, means, or instructions for obtaining the uplink shared channel message according to the one or more rules, where the one or more rules indicate that the PO may be valid based on one or more time resources associated with the PO being different from one or more second time resources associated with one or more second POs.

In some examples of the method, network entities, and non-transitory computer-readable medium described herein, obtaining the uplink shared channel message may include operations, features, means, or instructions for obtaining the uplink shared channel message according to the one or more rules, where the one or more rules indicate that the PO may be valid based on a first set of time-frequency resources associated with the PO being different from a second set of time-frequency resources associated with one or more ROs.

In some examples of the method, network entities, and non-transitory computer-readable medium described herein, the one or more ROs may be associated with the two-step RACH procedure, a four-step RACH procedure, or both.

In some examples of the method, network entities, and non-transitory computer-readable medium described herein, the one or more ROs may be associated with the SBFD configuration, a TDD configuration, or both.

In some examples of the method, network entities, and non-transitory computer-readable medium described herein, the one or more POs include POs dedicated for SBFD operations.

In some examples of the method, network entities, and non-transitory computer-readable medium described herein, obtaining the uplink shared channel message may include operations, features, means, or instructions for obtaining the uplink shared channel message according to the one or more rules, where the one or more rules indicate that the PO may be valid based on the PO beginning at least a first threshold quantity of symbols after a first BBB or a first broadcast channel message and beginning a second threshold quantity of symbols before a second BBB or second broadcast channel message.

In some examples of the method, network entities, and non-transitory computer-readable medium described herein, obtaining the uplink shared channel message may include operations, features, means, or instructions for obtaining the uplink shared channel message according to the one or more rules, where the one or more rules indicate that the PO may be valid based on the PO beginning at least a threshold quantity of symbols after a previous downlink symbol.

Some examples of the method, network entities, and non-transitory computer-readable medium described herein may further include operations, features, means, or instructions for obtaining, from the UE, an indication of a SBFD capability of the UE.

### BRIEF DESCRIPTION OF THE DRAWINGS

FIG. 1 shows an example of a wireless communications system that supports physical uplink shared channel (PUSCH) occasion (PO) validation in accordance with one or more aspects of the present disclosure.

FIG. 2 shows an example of a wireless communications system that supports PO validation in accordance with one or more aspects of the present disclosure.

FIG. 3 shows an example of a resource allocation diagram that supports PO validation in accordance with one or more aspects of the present disclosure.

FIG. 4 shows an example of a process flow that supports PO validation in accordance with one or more aspects of the present disclosure.

FIGS. 5 and 6 show block diagrams of devices that support PO validation in accordance with one or more aspects of the present disclosure.

FIG. 7 shows a block diagram of a communications manager that supports PO validation in accordance with one or more aspects of the present disclosure.

FIG. 8 shows a diagram of a system including a device that supports PO validation in accordance with one or more aspects of the present disclosure.

FIGS. 9 and 10 show block diagrams of devices that support PO validation in accordance with one or more aspects of the present disclosure.

FIG. 11 shows a block diagram of a communications manager that supports PO validation in accordance with one or more aspects of the present disclosure.

FIG. 12 shows a diagram of a system including a device that supports PO validation in accordance with one or more aspects of the present disclosure.

FIGS. 13 and 14 show flowcharts that support PO validation in accordance with one or more aspects of the present disclosure.

### DETAILED DESCRIPTION

In some wireless communications systems, a user equipment (UE) may perform a four-step random access channel (RACH) procedure or a two-step RACH procedure to connect with a network entity. In some cases, the two-step RACH procedure may involve the UE transmitting a MsgA (e.g., a first random access (RA) message) to a network entity, and the network entity may transmit a MsgB (e.g., a second RA message) to the UE (e.g., in response to receiving and decoding the MsgA). The MsgA may include a preamble portion and a physical uplink shared channel (PUSCH) portion (e.g., similar to Msg1 and Msg3, respectively, of the four-step RACH procedure), where the UE may transmit the preamble portion in a RACH occasion (RO) and the PUSCH portion in a PUSCH occasion (PO). In some cases, the UE may receive an indication of one or more ROs, POs, or both, and the UE may select a PO for transmitting the PUSCH portion of the MsgA based on validating the PO. Additionally, a wireless communications system may implement sub-band full-duplex (SBFD) operations, where a time resource may be associated with both uplink and downlink signaling in respective frequency bandwidths (e.g., sub-bands) associated with the time resource. In some cases, a network entity may transmit an SBFD configuration (e.g., an SBFD-UL-DL-Configuration) to the UE to identify SBFD slots (e.g., slots which may be associated with SBFD operations). In some cases, the UE may not be capable of (e.g., or may not have clearly defined rules for) validating POs associated with SBFD operations, including SBFD-dedicated POs (e.g., or POs that are in SBFD slots). Thus, a method for validating (e.g., determining the validity of in accordance with one or more rules, for instance) POs for MsgA transmission in SBFD systems may be beneficial.

According to techniques described herein, a UE may transmit the PUSCH portion of the MsgA via a PO based on a validity of the PO, where the validity of the PO may be based on one or more rules associated with the SBFD configuration. For example, the UE may receive the SBFD configuration and a message indicating one or more POs, and the UE may transmit the PUSCH portion of the MsgA via a valid PO of the one or more POs, where the validity of the PO may be based on one or more rules associated with the SBFD configuration. In some cases, one or more of the POs identified by the message may be SBFD-dedicated POs (e.g., POs configured for UEs with SBFD capabilities (e.g., and possibly not indicated to other (e.g., legacy) UEs)), which may include POs configured in one or more SBFD slots.

The one or more rules may indicate one or more conditions for validating a PO in an SBFD system. Different scenarios, deployments, or factors may be associated with different rules such that only a subset of the one or more rules may be applicable, for instance. For example, in some cases, the one or more rules may indicate that a PO is valid based on whether the PO is in an uplink sub-band (UL-SB) of an SBFD slot. Additionally, or alternatively, the one or more rules may indicate that the PO is valid based on whether the PO is in a slot with a specified slot format (e.g., uplink, flexible, downlink). Additionally, or alternatively, the one or more rules may indicate that the PO is valid based on whether the resources (e.g., time resources, frequency resources, time-frequency resources) of the PO overlap with resources for another PO or RO. For example, the other PO, RO, or both, may be a valid PO, RO, or both, respectively, and the other PO, RO, or both, may be SBFD-dedicated or not (e.g., legacy). Additionally, or alternatively, the one or more rules may indicate that the PO is valid based on a location of the PO relative to an SSB, a physical broadcast channel (PBCH) block, a downlink symbol, or any combination thereof. For example, the PO may be valid if the PO is not before an SSB or PBCH block in a slot (e.g., if there is an SSB or PBCH block in the slot), and if the PO is at least a threshold quantity (e.g., N_{gap}, a gap) of symbols after or before an SSB, a PBCH block, or a downlink symbol.

Aspects of the disclosure are initially described in the context of wireless communications systems. Aspects of the disclosure are also described in the context of resource allocation diagrams and process flows. Aspects of the disclosure are further illustrated by and described with reference to apparatus diagrams, system diagrams, and flowcharts that relate to PO validation.

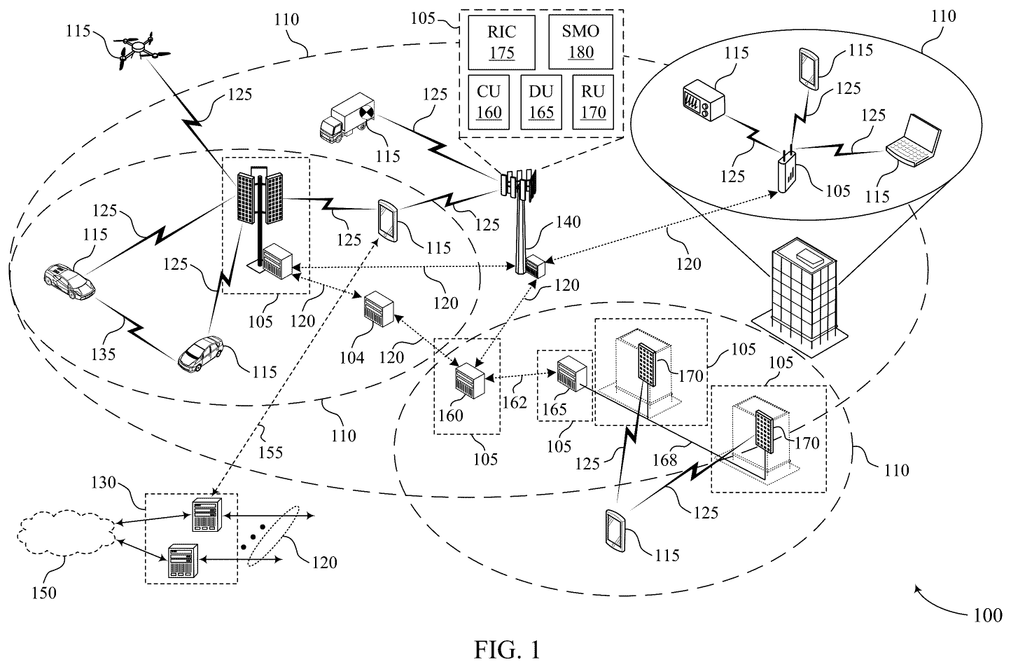

FIG. 1 shows an example of a wireless communications system 100 that supports PO validation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communications systems, a UE 115 may perform a four-step RACH procedure or a two-step RACH procedure to connect with a network entity 105. In some cases, the two-step RACH procedure may involve the UE 115 transmitting a MsgA (e.g., a first RA message) to the network entity 105, and the network entity 105 may transmit a MsgB (e.g., a second RA message) to the UE 115 (e.g., in response to receiving and decoding the MsgA). The MsgA may include a preamble portion and a PUSCH portion (e.g., similar to Msg1 and Msg3, respectively, of the four-step RACH procedure), where the UE 115 may transmit the preamble portion in an RO and the PUSCH portion in a PO. In some cases, the UE 115 may receive a message indicating one or more ROs and POs (e.g., a PO configuration), and may select a PO for transmitting the PUSCH portion of the MsgA based on validating the PO. Additionally, the wireless communications systems may implement SBFD operations, where a time resource (e.g., a symbol, a slot) may be associated with both uplink and downlink signaling in respective frequency bandwidths (e.g., sub-bands) associated with the time resource. In some cases, a network entity 105 may transmit an SBFD configuration (e.g., an SBFD-UL-DL-Configuration) to the UE 115 to identify SBFD slots (e.g., slots which may be associated with SBFD operations) of a set of one or more slots. In some cases, the UE may not be capable of validating POs associated with SBFD operations, which may include SBFD-dedicated POs (e.g., POs dedicated for UEs 115 with SBFD capabilities, POs configured in SBFD slots). Thus, a method for validating (e.g., determining the validity of) POs for MsgA transmission in SBFD systems may be beneficial.

According to techniques described herein, a UE 115 may transmit the PUSCH portion of the MsgA via a PO based on a validity of the PO, where the validity of the PO may be based on one or more rules associated with receiving the SBFD configuration. For example, the UE 115 may receive the SBFD configuration and a message indicating one or more POs (e.g., a PO configuration, as described herein), and the UE 115 may transmit the PUSCH portion of the MsgA (e.g., to a network entity 105) via a valid PO of the one or more POs, where the validity of the valid PO may be based on one or more rules associated with the SBFD configuration. In some cases, one or more of the POs indicated in the message may be SBFD dedicated POs. An SBFD-dedicated PO may be a PO that is configured for UEs 115 with SBFD capabilities (e.g., and possibly not indicated to other (e.g., legacy) UEs 115). Additionally, POs configured in SBFD symbols (e.g., symbols of an SBFD slot) may be SBFD-dedicated POs, and some POs configured in non-SBFD symbols may be SBFD-dedicated POs.

The one or more rules may indicate one or more conditions for the UE 115 (e.g., and the network entity 105) to validate a PO in an SBFD system. In some examples, the one or more rules may indicate that a PO is valid based on whether the PO is in an UL-SB of an SBFD slot. The one or more rules may also indicate that the PO is valid based on whether the PO is in a slot with a specified slot format (e.g., uplink, flexible, downlink). The one or more rules may also indicate that the PO is valid based on whether the resources of the PO overlap with resources for another PO or RO. For example, the other PO, RO, or both, may be a valid PO, RO, or both, respectively, and the other PO, RO, or both, may be SBFD-dedicated or not (e.g., legacy). The one or more rules may also indicate that the PO is valid based on a location of the PO relative to an SSB, a PBCH block, a downlink symbol, or any combination thereof. For example, the PO may be valid if the PO is not before an SSB or PBCH block in a slot (e.g., if there is an SSB or PBCH block in the slot), and if the PO is at least a threshold quantity (e.g., N_{gap}, a gap) of symbols after or before an SSB, a PBCH block, or a downlink slot.

In some cases, implementing the techniques described herein may allow for less latency in RACH procedures for SBFD capable UEs. For example, a UE 115 (e.g., an SBFD capable UE) may determine a validity of one or more POs located in slots (e.g., downlink slots) which are for SBFD operations, allowing the UE 115 to transmit the PUSH portion of the MsgA in a slot that may not be available to other UEs 115 (e.g., non-SBFD capable UEs, legacy UEs). As used herein, the term “MsgA” may refer to the preamble portion of the MsgA, the PUSCH portion of the MsgA, or both, as described herein. Additionally, the term “SBFD-dedicated POs” may describe POs configured for UEs 115 with SBFD capabilities (e.g., and not configured for UEs 115 without SBFD capabilities), and may include POs configured in SBFD slots, one or more POs configured in non-SBFD slots, or both.

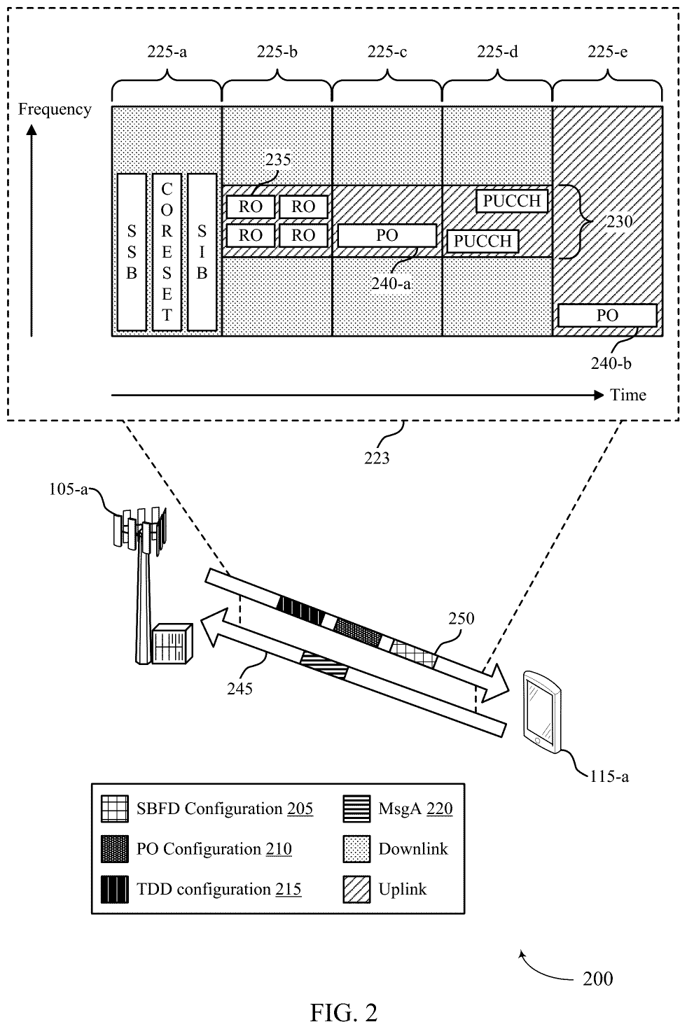

FIG. 2 shows an example of a wireless communications system 200 that supports PO validation in accordance with one or more aspects of the present disclosure. In some cases, aspects of the wireless communications system 200 may implement or be implemented by aspects of FIG. 1. For example, the wireless communications system 200 may include a network entity 105-a and a UE 115-a, which may be examples of the network entity 105 and the UE 115, respectively, as described herein with respect to FIG. 1. In some aspects, the UE 115-a may transmit a MsgA 220 (e.g., a PUSCH portion of the MsgA 220) via a PO 240 (e.g., a PO 240-a, a PO 240-b) within an uplink channel 245 based on a validity of the PO 240, where the validity of the PO 240 may be based on one or more rules associated with an SBFD configuration 205.

In some cases, the UE and the network entity 105-a may perform a two-step RACH procedure (e.g., two-step RACH). In some cases, the two-step RA may include a MsgA 220 and a MsgB, where the UE 115-a may transmit the MsgA 220 to the network entity 105-a and the network entity 105-a may transmit the MsgB to the UE 115-a in response to correctly receiving and decoding the MsgA 220. In some cases, the MsgA 220 may include a preamble portion (e.g., a MsgA preamble) and a PUSCH portion (e.g., a MsgA payload), where the preamble portion may be sent before the PUSCH portion. In some cases, the PUSCH portion may include a demodulation reference signal (DMRS). After successfully decoding the PUSCH portion of the MsgA 220, the network entity 105-a may transmit a PDSCH portion of MsgB (e.g., including a cell radio network temporary identifier (C-RNTI) or another MsgB-RNTI) and (e.g., subsequently) a PDSCH portion of the MsgB (e.g., a success RA response (RAR)). Based on receiving the PDSCH portion and having a valid timing advance (TA), PUCCH resource, or timing information, the UE 115-a may transmit a physical uplink control channel (PUCCH) message (e.g., a hybrid automatic request (HARQ) acknowledgement or not-acknowledgement) to the network entity 105-a.

In some cases, performing a two-step RACH procedure may reduce latency and signaling overhead of for the UE 115-a and the network entity 105-a when compared to a four step RACH procedure (e.g., four-step RACH). Additionally, or alternatively, the two-step RACH procedure may support small uplink packet transmission without communicating a TA, a grant for communications, or both. Additionally, or alternatively, the two-step RACH procedure may support the use of different transport block sizes (TBSs) and modulation and coding schemes (MCSs) when compared to the four-step RACH procedure. Additionally, or alternatively, performing the two-step RACH procedure may increase a capacity and power efficiency of the UE 115-a and the network entity 105-a compared to the four-step RACH procedure (e.g., or contention based random access (CBRA)). Additionally, or alternatively, the UE 115-a and the network entity 105-a may use the two step RACH procedure in place of a RACH-less handover procedure.

In some cases, the UE 115-a and the network entity 105-a may perform the two-step RACH procedure according to a resource configuration for MsgA 220 (e.g., including CBRA). For example, the network entity 105-a (e.g., or another network entity) may pre-configure one or more (e.g., up to two) MsgA PUSCH configurations for each RRC state (e.g., active, idle, inactive, connected) in an initial or active uplink bandwidth part (BWP) (e.g., such as an UL-SB 230 (e.g., uplink bandwidth part) or a slot 225-e as described herein) for one or more UEs 115 including the UE 115-a. In some cases, each MsgA PUSCH configuration may include (e.g., be based on) one or more group-specific configuration parameters. For example, the group-specific configuration parameters may include a slot-level offset between a MsgA physical random access channel (PRACH) (e.g., for the preamble portion of MsgA 220, an RO) and MsgA PUSCH, a quantity of POs 240 for MsgA 220 that may be FDMed, a time domain resource allocation (TDRA), a frequency domain resource allocation (FDRA), an MCS, a TBS, a preamble to PUSCH mapping ratio (e.g., a quantity of ROs versus a quantity of POs, a quantity of available preamble portions for MsgA 220 versus a quantity of available PUSCH portions for MsgA 220), a DMRS resource configuration (e.g., a sequence and a port), a configuration for intra-slot frequency hopping, a configuration for a physical RB (PRB)-level guard band, a configuration for a symbol-level guard period after transmission of a PUSCH portion of the MsgA 220, or any combination thereof.

In some cases, the UE 115-a may share one or more resources, including ROs, preamble groups, DMRS resources, and POs, with one or more other UEs 115. For example, the UE 115-a may share the one or more resources with the other UEs 115 based on performing a contention-based non-orthogonal multiple access (NOMA) procedure. As described herein, the two-step RACH procedure may be TA-free and grant free.

In some cases, the UE 115-a (e.g., and the network entity 105-a) may determine if a PO 240 is valid (e.g., validate the PO 240), where each PO may be associated with a set of one or more DMRS resources. For example, a PO 240 may be valid if the PO 240 does not overlap in time and frequency (e.g., in time or frequency) with an RO 235 (e.g., a valid PRACH occasion) associated with either a four-step RACH procedure (e.g., a Type-1 RACH procedure) or a two-step RACH procedure (e.g., a Type-2 RACH procedure).

Additionally, or alternatively, the UE 115-a (e.g., and the network entity 105-a) may validate POs in unpaired spectrum and POs in SSB or PBCH blocks, which may have indexes provided by a position configuration (e.g., ssb-PositionsInBurst in SIB1) or by a serving cell configuration (e.g., ServingCellConfigCommon). For example, the UE 115-a may receive a time division duplexing (TDD) configuration 215 (e.g., tdd-UL-DL-ConfigurationCommon), which may indicate a slot format of one or more slots 225, as described in the resource allocation diagram 223. If the UE 115-a does not receive the TDD configuration 215, a PO 240 may be valid if the PO 240 does not precede an SSB or PBCH block in a same slot 225 (e.g., a PUSCH slot), or if the PO 240 begins (e.g., a first time resource associated with the PO 240) at least a second threshold quantity of symbols (e.g., N_{gap}) after a previous (e.g., last) SSB or PBCH block, and (e.g., if a channel access mode is provided to the UE 115-a and is set to “semiStatic”) if the PO 240 does not overlap with a set of consecutive symbols before a start of a next channel occupancy time where the UE 115-a does not transmit or refrains from transmission. Additionally, if the UE 115-a does receive the TDD configuration 215, the PO 240 may be valid if the PO is within an uplink symbol.

In some cases, the UE 115-a may select an RO 235 and a PO 240 (e.g., a corresponding PO 240, along with an associated DMRS resource) from one or more ROs 235 and one or more POs 240, respectively. In some cases, the one or more ROs 235 may be associated with one or more preamble indexes, where one or more consecutive preamble indexes (e.g., a quantity N_{preamble} of consecutive preamble indexes) of valid ROs may each be mapped to a valid PO of the one or more POs 240 (e.g., and the associated DMRS resource). For example, the preamble indexes may be ordered by increasing preamble index, then by increasing order of frequency resources, and then by increasing order of time resources. Additionally, or alternatively, the POs may be ordered by increasing order of frequency resources, then by increasing order of DMRS resources, then by increasing order of time resources, and then by increasing order of PUSCH slots.

As described herein, the UE 115-a and the network entity 105-a may communicate via a downlink channel 250 and the uplink channel 245. In some cases, the downlink channel 250 and the uplink channel 245 may include wireless communications resources divided into slots 225 (e.g., divided in the time domain, a slot 225-a, a slot 225-b, a slot 225-c, a slot 225-d, and a slot 225-c) and divided into sub-bands (e.g., divided in the frequency domain). For example, the resource allocation diagram 223 may include SBFD slots such as the slots 225-b, 225-c, and 225-d, which may include the UL-SB 230.

In some cases, the UE 115-a may receive the TDD configuration 215 (e.g., the tdd-UL-DL-ConfigurationCommon), which may indicate a slot format for one or more of the slots 225. Additionally, or alternatively, the UE 115-a may receive the SBFD configuration 205 (e.g., SBFD-UL-DL-Configuration), which may indicate the slots that are for SBFD operations, or both. For example, the TDD configuration 215 may indicate that slots 225-a, 225-b, 225-c, and 225-d are downlink slots, and that slot 225-e is an uplink slot. The TDD configuration 215 may also indicate that one or more of the slots 225 are flexible slots, which may be used for either uplink or downlink. Additionally, or alternatively, the SBFD configuration 205 may indicate that slots 225-b, 225-c, and 225-d are for SBFD operations, and may indicate one or more frequencies or bandwidths included in the UL-SB 230. Although the resource allocation diagram 223 may include a quantity of allocations (e.g., the slots 225, the UL-SB 230, the ROs 235, the POs 240, SSBs, PBCH blocks) and locations of the allocations, the techniques described herein may apply to any quantity and location of the allocations.

In some cases, the UE 115-a and the network entity 105-a may perform RACH procedures (e.g., the two-step RACH procedure) via SBFD slots (e.g., via SBFD symbols in the slots 225). In some cases, performing RACH procedures using SBFD slots may be associated with one or more benefits for the wireless communications system 200. For example, performing RACH procedures using SBFD slots may allow the UE 115-a to utilize the UL-SB 230 in consecutive slots 225 to enable repetition and frequency hopping for the preamble portion, the PUSCH portion, or both, of the MsgA 220, which may enhance an uplink coverage for initial access. Additionally, or alternatively, some (e.g., additional) ROs may be within the UL-SB 230, which may improve RACH capacity (e.g., a quantity of UEs 115 performing RACH procedures simultaneously) and reduce the contention-based collisions probability, while enabling more UEs 115 to access the network. Performing RACH procedures using SBFD slots may reduce a latency at the UE 115-a associated with RACH procedures, and may reduce latency associated with initial access and handover operations in the wireless communications system 200 (e.g., especially if the wireless communications system 200 includes layer mobility (e.g., L1/L2 mobility)).

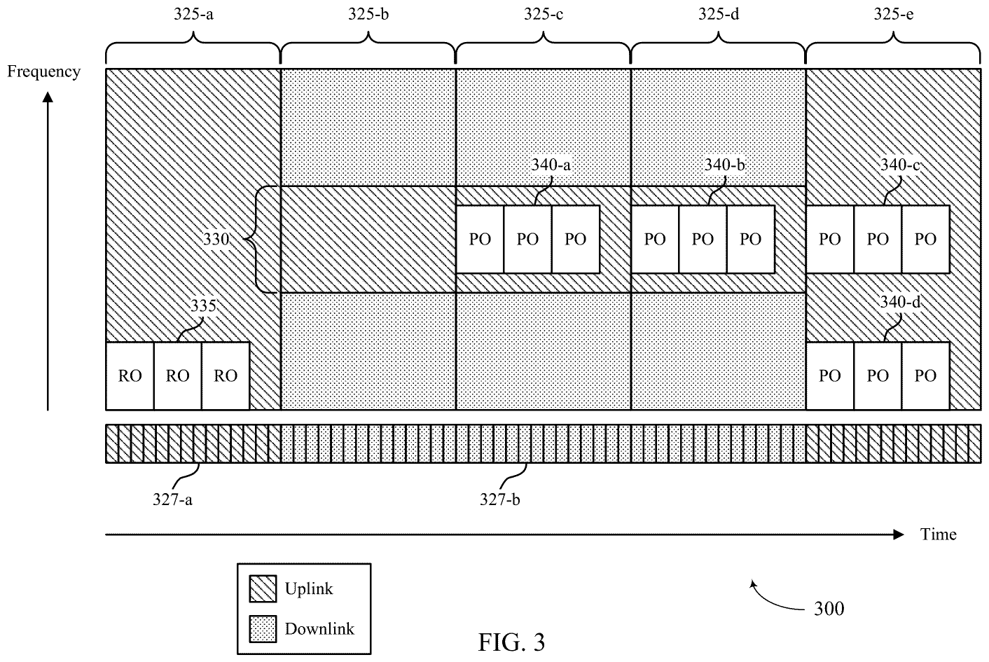

In some aspects, this disclosure may indicate one or more operations associated with RACH procedures in an SBFD system. For example, the disclosure may specify operation of the UE 115-a (e.g., an SBFD capable UE) to support RA in one or more SBFD symbols (e.g., such as symbol 327-b, as described herein with reference to FIG. 3) or SBFD slots. In some cases, the UE 115-a may be in an RRC connected mode, an RRC idle mode, an RRC inactive mode, or another RRC mode.

The ROs 235 and the POs 240 of the wireless communications system 200 (e.g., and in SBFD slots or symbols) may be configured in one or more ways. In a first example, the UE 115-a may receive a single PO configuration 210 indicating the POs 240 (e.g., for MsgA 220) associated with SBFD operations (e.g., SBFD-dedicated POs) and associated with TDD operations (e.g., legacy POs). In some cases, the first example may allow for a single configuration (e.g., no extra signaling or overhead), and may allow UEs 115 without SBFD capabilities to leverage ROs 235 in SBFD slots that are configured as flexible slots (e.g., via the TDD configuration 215). However, the first example may also cause mapping ambiguity between SSBs and ROs between the UE 115-a (e.g., SBFD capable UEs, SBFD aware UEs) and other UEs 115 (e.g., UEs without SBFD capabilities, non-SBFD aware UEs). The first example may also cause resource fragmentation in an uplink slot when the UL-SB 230 is not at an edge (e.g., in the middle) of the bandwidth of the uplink slot.

In some cases, the first example may include RO and PO configuration such that the UE 115-a (e.g., UEs 115 with SBFD capabilities) and the other UEs 115 have a same sets of valid ROs and valid POs. For example, the first example may configure the ROs 235 and the POs 240 in either SBFD symbols configured in flexible slots, or non-SBFD symbols. This may allow for the first example to be compatible with the UE 115-a and the other UEs 115, and may alleviate inconsistency in mappings between SSBs and ROs 235, as well as mapping between preambles portions of the MsgA 220 and the POs 240.

As a second example, the wireless communications system 200 (e.g., specifically the network entity 105-a) may include separate indications of ROs 235 and POs 240 associated with SBFD operations (e.g., SBFD-dedicated POs) in addition to an indication of ROs and POs associated with TDD operations (e.g., legacy POs). For example, the UE 115-a may receive the PO configuration 210, which may configure one or more of the POs 240 separately for the UE 115-a (e.g., a UE 115 with SBFD capabilities) than for other UEs 115 (e.g., UEs without SBFD capabilities). In some cases, in the second example, one or more of the ROs 235 and the POs 240 may be SBFD-dedicated ROs and SBFD-dedicated POs, respectively.

In some cases, the second example may allow the PO configuration 210 to have separate parameters for SBFD-dedicated POs, and may allow for independent mapping between SSBs and ROs 235 (e.g., or between preamble portions and POs 240) between the UE 115-a and the other UEs 115. For example, according to the second example, the network entity 105-a may be configured with SBFD-dedicated RO time-frequency resource parameters, RO or PO power configuration parameters (e.g., to accommodate uplink link quality settings), or both, in UL-SB 230, which may be different for non-SBFD-dedicated ROs and POs. However, the second example may include increased signaling and overhead, and may cause the SBFD-dedicated ROs and POs to be unavailable (e.g., not applicable) to the other UEs 115 (e.g., non-SBFD aware UEs).

In some aspects, this disclosure may pertain to the first example and the second example for RO and PO configuration (e.g., as described herein). Accordingly, the disclosure may describe validity rules for POs 240 (e.g., and for ROs 235) in SBFD capable systems (e.g., and for POs 240 in SBFD slots or symbols).

FIG. 3 shows an example of a resource allocation diagram 300 that supports PO validation in accordance with one or more aspects of the present disclosure. In some cases, aspects of the resource allocation diagram 300 may implement or be implemented by aspects of FIGS. 1 and 2. For example, the resource allocation diagram 300 may be an example of the resource allocation diagram 223, as described herein with respect to FIG. 2, and may describe resource allocations for communication between at least one UE 115 and a network entity 105 (e.g., such as the UE 115-a and the network entity 105-a). In some cases, a UE 115 may validate (e.g., or invalidate) one or more POs 340 based on one or more rules associated with SBFD operation and the SBFD configuration (e.g., as describe herein with respect to FIG. 2).

Although the resource allocation diagram 300 may include a quantity of allocations (e.g., the slots 325, the UL-SB 330, the ROs 335, the POs 340, symbols 327) and locations of the allocations, the techniques described herein may apply to any quantity and location of the allocations. Additionally, or alternatively, the POs 340 may include multiple groups of POs, each group of POs including one or more POs 340 (e.g., 3 POs 340). However, each of the POs 340 (e.g., POs 340-a, POs 340-b, POs 340-c, POs 340-d) may include any quantity of POs 340, and the quantity included in the resource allocation diagram 300 is merely exemplary.

As described herein, the UE 115 may validate one or more POs 340 based on one or more rules associated with SBFD operations. Some of the one or more rules may apply for PO validation in some cases, and may not apply in other cases. For example, the UE 115 may receive a message indicating one or more of the POs 340 (e.g., such as the PO configuration 210, indicating resources associated with one or more of the POs 340). In some cases, at least one of the POs 340 indicated by the message may be SBFD-dedicated POs, which may be POs 340 that are configured for UEs with SBFD capabilities (e.g., and not configured for or to UEs without SBFD capabilities). In some other cases, the POs 340 indicated by the message may be configured for UEs 115 irrespective of the SBFD capabilities of the UEs 115 (e.g., non-SBFD-dedicated POs). Additionally, or alternatively, in some cases, the UE 115 may receive the TDD configuration (e.g., such as the TDD configuration 215 as described herein with respect to FIG. 2) indicating slot formats (e.g., uplink, downlink, flexible) for the slots 325. The symbols 327 may each correspond to a slot 325, such that each symbol may have a same format (e.g., uplink, downlink flexible) as the slot 325 it corresponds to. In some other cases, the UE 115 may not receive the TDD configuration. In some aspects, rules for PO validation may apply to different cases as described herein.

In a first case (e.g., a first exemplary case), the message indicating the one or more POs 340 may indicate one or more SBFD-dedicated POs, and the UE 115 may receive the TDD configuration along with an SBFD configuration (e.g., such as the SBFD configuration 205, as described herein with respect to FIG. 2). In the first case, a PO 340 may be valid if the PO is within the UL-SB 330 of symbols 327 associated with SBFD operations (e.g., an SBFD symbol, the symbol 327-b, symbols within the slots 325-b, 325-c, and 325-d, which are slots 325 associated with SBFD operations), where the symbols 327 associated with SBFD operations may be within a downlink slot or a flexible slot (e.g., indicated by the TDD configuration (e.g., tdd-UL-DL-ConfigurationCommon)). Additionally, the PO 340 may be valid if the PO does not precede an SSB or PBCH block a respective slot 325, and begins (e.g., starts) at least a first threshold quantity (e.g., N_{gap}) of symbols after a last downlink symbol and at least a second threshold quantity of symbols after a last SSB or PBCH block symbol. In the first case, the PO 340 may not be valid in non-SBFD symbols (e.g., uplink slots, flexible slots, slots 325-a and 325-c).

In the first case (e.g., and using the resource allocation diagram 300 as an example), the POs 340-a and the POs 340-b may be valid based on the POs 340-a and the POs 340-b being within the UL-SB 330 and the slots 325-c and 325-d being downlink (e.g., or flexible) slots. However, the POs 340-c and the POs 340-d may not be valid based on the POs 340-c and the POs 340-d being in the slot 325-e, which may be an uplink slot.

Additionally, or alternatively, in the first case, the PO 340 may be valid if the PO 340 is within an uplink slot. For example, in the first case, the POs 340-c and the POs 340-d may be valid based on being in the slot 325-e, which may be an uplink slot. Additionally, or alternatively, in the first case, the PO 340 may be valid if the PO 340 is within a flexible slot (e.g., a flexible symbol, a symbol 327 of a flexible slot), and does not precede an SSB or PBCH block in the same slot 325, and begins least a first threshold quantity of symbols 327 after a previous (e.g., last) downlink symbol and at least a second threshold quantity of symbols 327 after a previous SSB or PBCH block symbol. For example, in the first case, the POs 340-c and the POs 340-d may be valid based on being in the slot 325-e, which may be a flexible slot.

In a second case (e.g., a second example), the message indicating the one or more POs 340 may indicate one or more SBFD-dedicated POs and the UE 115 may receive the SBFD configuration, but the UE 115 may not receive the TDD configuration. In the second case, a PO 340 may be valid if the PO is within the UL-SB 330 of an SBFD symbol (e.g., symbols 327 of the slots 325-b, 325-c, and 325-d) and does not precede an SSB or PBCH block in the same slot, and if the PO 340 begins at least the second threshold quantity of symbols after a previous SSB or PBCH block symbol.

In the second case (e.g., and using the resource allocation diagram 300 as an example), the POs 340-a and 340-b may be valid based on the POs 340-a and the POs 340-b being in the slots 325-c and 325-d, which may include symbols 327 that are associate with SBFD operations (e.g., SBFD symbols). However, in the second case, the POs 340-c and the POs 340-d may not be valid based on being in the slot 325-e, which may not be an SBFD slot.

Additionally, in the second case, the PO 340 may be valid if the PO 340 is within a flexible symbol (e.g., symbols 327 in a flexible slot, SBFD flexible slots or non-SBFD flexible slots). For example, in the second case, the POs 340-a, 340-b, 340-c, and 340-d may be valid based on being in the slots 325-c, 325-d, and 325-e, which may be flexible slots. In some cases, if the UE 115 is not provided the TDD configuration (e.g., as in the second case), then all symbols 327 (e.g., all symbols 327 that are included in the slots 325 which would be indicated in the TDD configuration) may be flexible symbols.

In a third case (e.g., a third example), the one or more POs 340 indicated by the message may not include SBFD-dedicated POs, and the UE 115 may receive the TDD configuration along with an SBFD configuration. In the third example, a PO 340 may be valid if the PO 340 is within an UL symbol (e.g., a symbol of an uplink slot). Additionally, or alternatively, in the third case, the PO 340 may be valid if the PO 340 is within the UL-SB 330 of an SBFD symbol in a flexible symbol (e.g., a symbol in a flexible slot), or is within a flexible symbol, and if the PO 340 does not precede as SSB or PBCH block in the same slot 325, and begins at least a first threshold quantity of symbols after a previous downlink symbol and at least a second threshold quantity of symbols after a previous SSB or PBCH block symbol. Thus, in the third case, POs may not be valid in SBFD downlink symbols or TDD downlink symbols. In some cases, PO validation according to these rules in the third case may achieve backwards compatibility with non-SBFD aware UEs, such that a same PO configuration may be transmitted to SBFD-aware and non-SBFD aware UEs.

As an example of PO validation in the third case, and assuming that the slot 325-c is a downlink slot (e.g., an SBFD downlink slot) and the slot 325-d is a flexible slot (e.g., an SBFD flexible slot), the POs 340-b, 340-c, and 340-d may be valid based on being in slots 325-d and 325-c, which may be a flexible slot and an uplink slot, respectively. However, in the third case, the POs 340-a may not be valid based on being in the slot 325-c, which may be a downlink slot (e.g., an SBFD downlink slot).

Additionally, in the third case, the PO 340 may be valid if the PO 340 is within the UL-SB 330 of an SBFD symbol of a downlink symbol (e.g., a symbol 327 of a downlink slot). For example, in the third case, and assuming the slot 325-c is a downlink slot (e.g., an SBFD downlink slot), the POs 340-a may be valid based on the POs 340-a being in the UL-SB 330 of the slot 325-c, which may be a downlink slot (e.g., an SBFD downlink slot). Thus, in the third case, POs 340 may be valid in SBFD-downlink symbols, and may not be valid in non-SBFD downlink symbols (e.g., TDD-DL-symbols). In some cases, employing the rules for PO validation in the third case may include generating a second mapping of preamble portions to POs for SBFD aware UEs that is different than a first mapping of preamble portions to POs for non-SBFD aware UEs.

In a fourth case (e.g., a fourth example), the one or more POs 340 indicated by the message may not include SBFD-dedicated POs, and the UE 115 may not receive the TDD configuration (e.g., but may receive the SBFD configuration). In the fourth case, a PO 340 may be valid if the PO 340 is within the UL-SB 330 of an SBFD symbol or is within any type of symbol (e.g., any uplink symbol, such as the symbol 327-a), and if the PO 340 does not precede an SSB or PBCH block in the same slot 325, and if the PO 340 begins at least a second threshold quantity of symbols after a previous SSB or PBCH block symbol. As described herein, if the UE 115 does not receive the TDD configuration, then the UE 115 may assume that the symbols 327 (e.g., and the slots 325) are flexible. Additionally, due to the UE 115 not receiving the TDD configuration in the fourth case, the UE 115 (e.g., an SBFD-aware UE) and other UEs (e.g., legacy UEs) may validate similar (e.g., the same) POs 340 within the frequency resources of the UL-SB 330.

In the fourth case (e.g., and using the resource allocation diagram 300 as an example), the POs 340-a, 340-b, 340-c, and 340-d may be valid based on either being in the UL-SB 330 of the slots 325-c and 325-d (e.g., SBFD slots with SBFD symbols), or based on being in the slot 325-e (e.g., an uplink slot with uplink symbols).

In some cases, the message may indicate one or more SBFD-dedicated POs to the UE 115, and at least one of the SBFD-dedicated POs may overlap in wireless communication resources with one or more other POs (e.g., in an uplink slot, in a flexible slot). For example, the POs 340-c may be SBFD-dedicated POs and the POs 340-d may be other POs (e.g., legacy POs, POs 340 configured for non-SBFD aware UEs), and the POs 340-c and 340-d may overlap in time resources. That is, time resources (e.g., of a first set of time-frequency resources) associated with the POs 340-c may be the same (e.g., not different) from time resources (e.g., of a second set of time-frequency resources) associated with the POs 340-d.

Accordingly, the one or more rules may indicate a validity of a PO 340 based on resource overlap with other POs 340 (e.g., other valid POs). For example, as part of the one or more rules, a PO 340 may be valid if the PO 340 is an SBFD-dedicated PO and does not overlap in either time resources or frequency resources with a different PO 340 (e.g., where the different PO 340 is a valid PO). In some cases, the different PO 340 may be a non-SBFD-dedicated PO (e.g., a legacy PO). For example, the POs 340-c may be SBFD-dedicated POs, and may overlap in time resources with the POs 340-d. Thus, the POs 340-c may be invalid according to the one or more rules based one the time resources associated with the POs 340-c being the same as the time resources associated with the POs 340-d.

Additionally, or alternatively, the one or more rules may indicate that SBFD-dedicated POs (e.g., such as the POs 340-c) are valid if the SBFD-dedicated POs do not overlap in frequency resources with another PO (e.g., a valid PO, a legacy PO). For example, the POs 340-c may be SBFD dedicated POs, and the POs 340-d may be the other POs (e.g., legacy POs, POs 340 not configured for non-SBFD aware UEs), and the POs 340-c may be associated with frequency resources that are different than frequency resources associated with the POs 340-d. Thus, according to the one or more rules. the POs 340-c may be valid based on the frequency resources associated with the POs 340-c being different from the frequency resources associated with the POs 340-d. In some cases, the one or more rules may allow for resources of POs 340 to overlap in time as long as they are scheduled in different frequency resources.

In some cases, each preamble portion of a MsgA (e.g., such as the MsgA 220 as described herein with reference to FIG. 2) may be mapped to a PO 340, and each preamble portion may also be associated with (e.g., mapped to) an SSB. In some cases, SBFD-dedicated POs are considered valid if the preambles of the SBFD-dedicated POs and the preambles associated with other POs (e.g., TDD POs, non-SBFD POs) are associated with a same SSB. Additionally, to effectuate the one or more rules for validating POs associated with SBFD operations, the UE 115 may first determine the validity of the other POs (e.g., the legacy POs, non-SBFD-dedicated POs), and then may determine the validity of the SBFD-dedicated POs.

In some cases, the message may indicate one or more SBFD-dedicated POs, and at least one or more SBFD-dedicated POs may overlap in resources (e.g., in time resources) with one or more ROs 335 (e.g., valid ROs). According to the one or more rules, an SBFD-dedicated PO may be valid if the SBFD-dedicated PO does not overlap in either time or frequency resources with the ROs 335 (e.g., a valid RO). In some cases, the ROs 335 may be SBFD-dedicated ROs or other ROs (e.g., legacy ROs, ROs configured for non-SBFD aware UEs). Additionally, or alternatively, the ROs 335 may be associated with the two-step RACH procedure or the four-step RACH procedure.

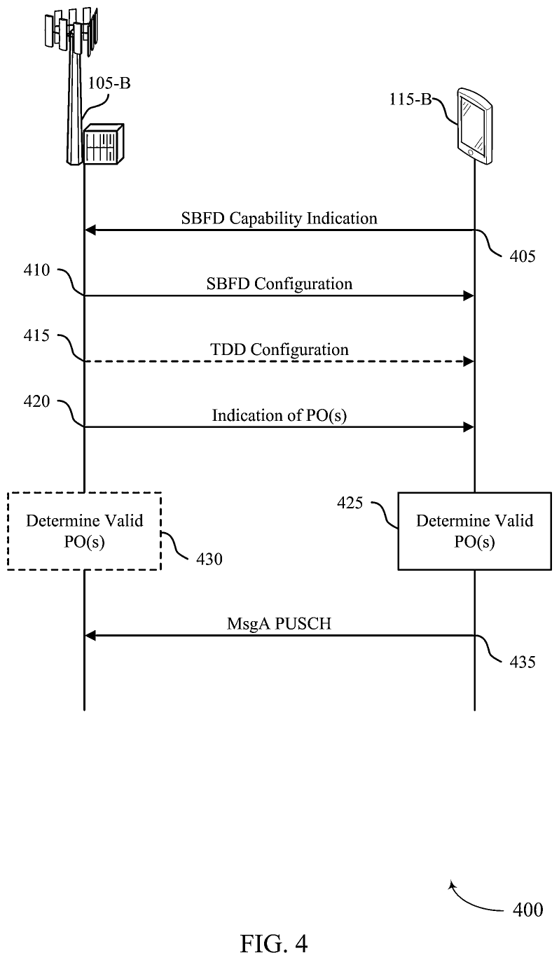

FIG. 4 shows an example of a process flow 400 that supports PO validation in accordance with one or more aspects of the present disclosure. In some cases, aspects of the process flow 400 may implement or be implemented by aspects of FIGS. 1-3. For example, the process flow 400 may include a network entity 105-b and a UE 115-b, which may be examples of the network entities 105 and the UEs 115 as described herein with respect to FIGS. 1-3. In some aspects, the UE 115-b may determine one or more valid POs based on one or more rules associated with SBFD operations, an SBFD configuration, or both.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Although the UE 115-b and the network entity 105-b are shown performing the operations of process flow 400, some aspects of some operations may also be performed by one or more other wireless devices or network devices.

At 405, the network entity 105-b may obtain, from the UE 115-b, an indication of an SBFD capability of the UE 115-b. For example, the SBFD capability may indicate whether the UE 115-b is capable of SBFD operations (e.g., receiving and transmitting in a same time resource via different sub-bands), a set of slots or other resources with which the UE 115-b is capable of performing SBFD operations, or both.

At 410, the UE 115-b may receive (e.g., from the network entity 105-b) an SBFD configuration for the UE 115-b, where the SBFD configuration may indicate one or more slots configured for sub-band full-duplex operations (e.g., such as slots 325-b, 325-c, and 325-c as described herein with respect to FIG. 3). In some cases, the SBFD configuration may be an example of the SBFD configuration 205, as described herein with respect to FIG. 2.

At 415, the UE 115-b may (e.g., from the network entity 105-b) receive a TDD configuration for the UE, the where the TDD configuration may indicate a slot format of a slot for communication between the UE 115-b and the network entity 105-b. In some cases, the slot may be of the one or more slots configured for SBFD operations. In some cases, the TDD configuration may be an example of the TDD configuration 215, as described herein with respect to FIG. 2.

At 420, the UE 115-b may receive (e.g., from the network entity 105-b) a message that may indicate one or more POs (e.g., uplink shared channel occasions, such as the POs 340 as described herein with respect to FIG. 3) for the UE 115-b to use for transmitting a PUSCH portion of a MsgA. In some cases, at least one PO of the one or more POs may be within a slot of the one or more slots configured for SBFD operations (e.g., via the SBFD configuration). In some cases, the one or more POs may include at least one PO that is dedicated for SBFD operations (e.g., an SBFD-dedicated PO, as described herein). Additionally, or alternatively, the one or more POs may include one or more POs associated with SBFD operations (e.g., SBFD-dedicated POs) and one or more POs associated with TDD operations (e.g., legacy POs).

At 425, the UE 115-b may determine a validity of (e.g., validate, determine whether valid) a PO (e.g., at least one PO) of the one or more POs indicated by the message at 420. As described herein, the validity of the PO may be based on one or more rules associated with the SBFD configuration, SBFD operations, or both.

In some examples (e.g., when the UE 115-b receives the TDD configuration at 415), the one or more rules may indicate that the PO is valid based on the slot format of the slot being (e.g., including) a downlink slot format or a flexible slot format according to the TDD configuration (e.g., when the PO is in an SBFD slot). Additionally, or alternatively, the one or more rules may indicate that the PO is valid based on the slot format of the slot being an uplink slot format or a flexible slot format according to the TDD configuration (e.g., when the PO is not in an SBFD slot).

In some examples (e.g., when the UE 115-b does not receive the TDD configuration at 415), the one or more rules may indicate that the PO is valid based on a slot format of the slot being a flexible slot format (e.g., when the PO is in an SBFD slot). Additionally, or alternatively, the one or more rules may indicate that the PO is valid based on the PO being within the UL-SB of a sub-band full-duplex symbol in the slot.

In some cases, the one or more rules may indicate that the PO is valid based on one or more frequency resources associated with the PO being different from one or more second frequency resources associated with one or more second POs, where one or more time resources associated with the one or more second POs may be the same as (e.g., overlap) with one or more time resources of the PO. For example, the PO and the one or more second POs may overlap in time resources in at least one symbol (e.g., such as a symbol 327 as described herein with respect to FIG. 3). Additionally, or alternatively, the one or more rules may indicate that the PO is valid based on one or more time resources associated with the PO being different from one or more second time resources associated with one or more second POs.

In some cases, the one or more rules may indicate that the PO is valid based on a first set of time-frequency resources (e.g., a set of resources including time and frequency resources) associated with the PO being different from a second set of time-frequency resources associated with one or more ROs. That is, time resources associated with the PO may be different from time resources associated with the one or more ROs, frequency resources associated with the PO may be different than frequency resources associated with the one or more ROs, or both. In some cases, the one or more ROs may be associated with the two-step RACH procedure (e.g., as described here), a four-step RACH procedure, or both. Additionally, or alternatively, the one or more ROs may be associated with the SBFD configuration (e.g., SBFD-dedicated ROs), the TDD configuration (e.g., legacy ROs), or both.

In some cases, the one or more rules may indicate that the PO is valid based on the PO beginning at least the second threshold quantity of symbols after a first SSB or a first broadcast channel message (e.g., PBCH block), and based on the PO beginning at least a third threshold quantity of symbols before a second SSB or a second broadcast channel message. In some cases, the one or more rules may indicate that the PO is valid based on the PO beginning at least the first threshold quantity of symbols after a previous downlink symbol. In some cases, the first threshold quantity of symbols may be the same as the second threshold quantity of symbols. Additionally, the third threshold quantity of symbols may be equal to 14 symbols, or one slot, such that the PO is not preceding an SSB or PBCH block within the same slot.

At 430, the network entity 105-b may determine the validity of the PO (e.g., at least one PO). In some cases, the network entity may determine the validity based at least a portion of the one or more rules associated with the sub-band full-duplex configuration. Thus, the network entity 105-b may determine the validity of the PO similarly to the UE 115-b, as described at 425.

At 435, the UE 115-b may transmit (e.g., and the network entity 105-b may obtain), via the PO of the one or more POs based on a validity of the PO, an uplink shared channel message (e.g., a PUSCH portion, a MsgA 220, as described herein with reference to FIG. 2) that may include at least a portion of a first RA message associated with a two-step RACH procedure (e.g., such as MsgA 220).

In some cases, the at least one PO within SBFD slots (e.g., indicated in the message at 420) may include the PO, and the UE 115-b may transmit the uplink shared channel message via an UL-SB (e.g., such as UL-SB 330, as described herein with respect to FIG. 3) of the slot, according to the one or more rules. According to these techniques, the UE 115-b may validate one or more POs according to one or more rules associated with SBFD operations.

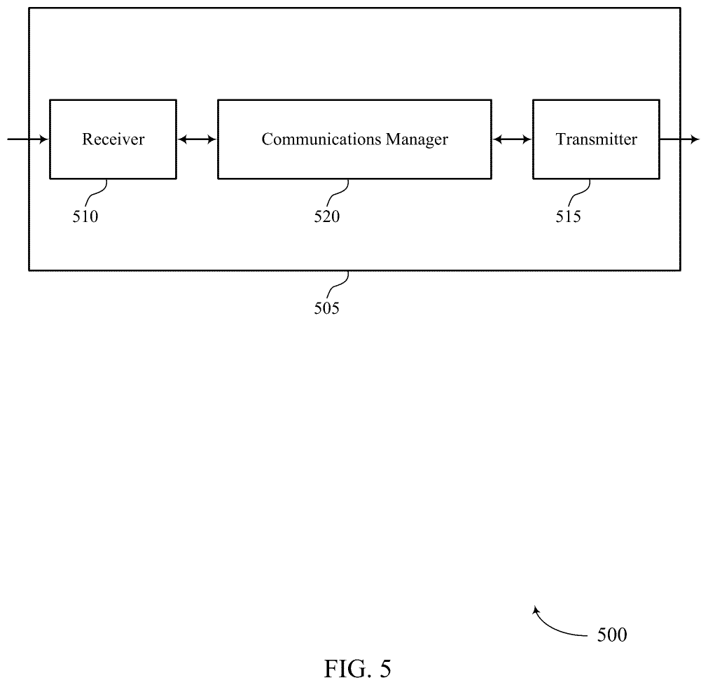

FIG. 5 shows a block diagram 500 of a device 505 that supports PO validation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to PO validation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to PO validation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of PO validation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a sub-band full-duplex configuration for the UE, the sub-band full-duplex configuration indicating one or more slots configured for sub-band full-duplex operations. The communications manager 520 is capable of, configured to, or operable to support a means for receiving a message indicating one or more uplink shared channel occasions for the UE, where at least one uplink shared channel occasion of the one or more uplink shared channel occasions is within a slot of the one or more slots configured for sub-band full-duplex operations. The communications manager 520 is capable of, configured to, or operable to support a means for transmitting, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources. For example, a UE 115 implementing the techniques described herein may be capable of validating one or more POs in UL-SBs of SBFD slots, which may allow the UE 115 to connect with a network entity 105 without using other POs for other (e.g., legacy) UEs.

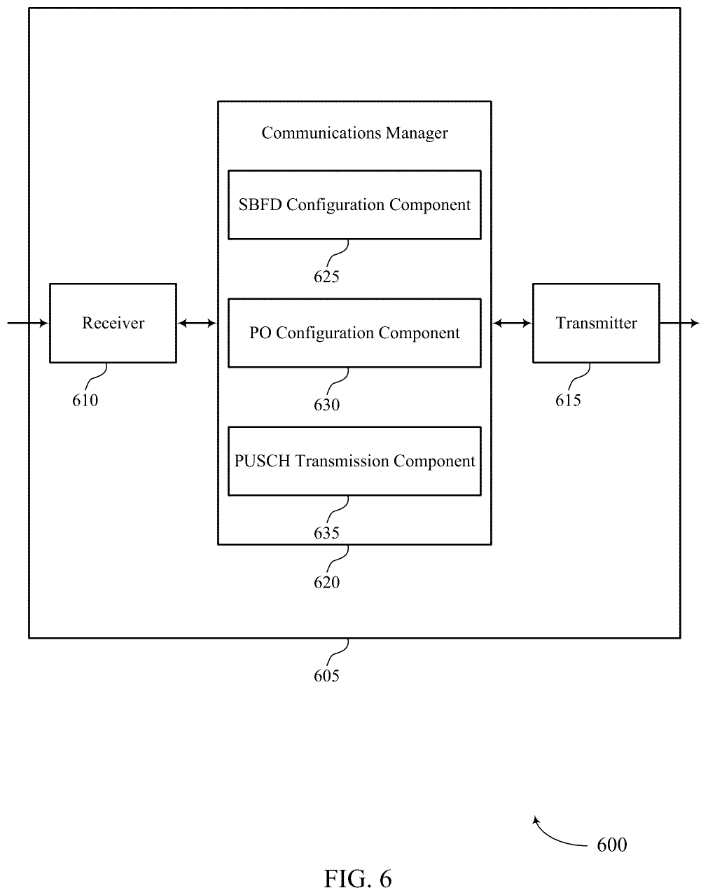

FIG. 6 shows a block diagram 600 of a device 605 that supports PO validation in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to PO validation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to PO validation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of PO validation as described herein. For example, the communications manager 620 may include an SBFD configuration component 625, a PO configuration component 630, an PUSCH transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SBFD configuration component 625 is capable of, configured to, or operable to support a means for receiving a sub-band full-duplex configuration for the UE, the sub-band full-duplex configuration indicating one or more slots configured for sub-band full-duplex operations. The PO configuration component 630 is capable of, configured to, or operable to support a means for receiving a message indicating one or more uplink shared channel occasions for the UE, where at least one uplink shared channel occasion of the one or more uplink shared channel occasions is within a slot of the one or more slots configured for sub-band full-duplex operations. The PUSCH transmission component 635 is capable of, configured to, or operable to support a means for transmitting, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

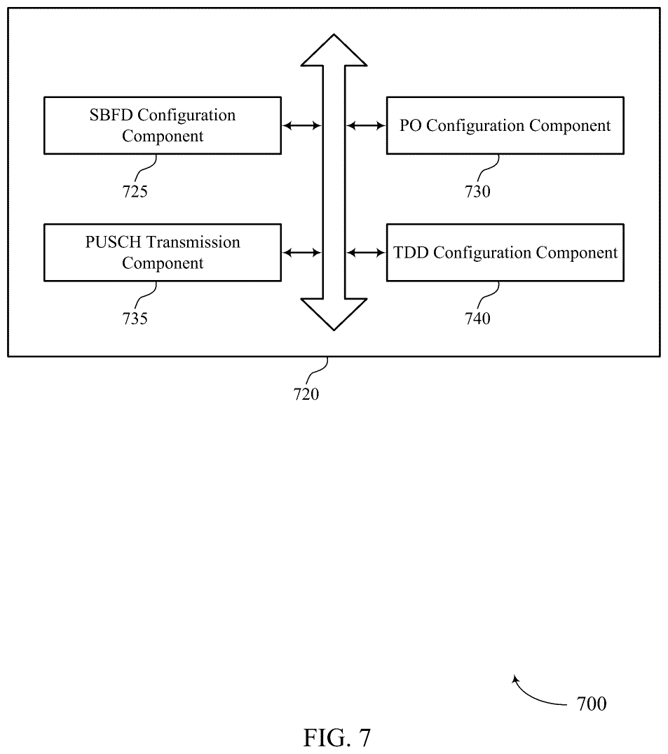

FIG. 7 shows a block diagram 700 of a communications manager 720 that supports PO validation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of PO validation as described herein. For example, the communications manager 720 may include an SBFD configuration component 725, a PO configuration component 730, an PUSCH transmission component 735, a TDD configuration component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SBFD configuration component 725 is capable of, configured to, or operable to support a means for receiving a sub-band full-duplex configuration for the UE, the sub-band full-duplex configuration indicating one or more slots configured for sub-band full-duplex operations. The PO configuration component 730 is capable of, configured to, or operable to support a means for receiving a message indicating one or more uplink shared channel occasions for the UE, where at least one uplink shared channel occasion of the one or more uplink shared channel occasions is within a slot of the one or more slots configured for sub-band full-duplex operations. The PUSCH transmission component 735 is capable of, configured to, or operable to support a means for transmitting, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

In some examples, to support transmitting the uplink shared channel message, the PUSCH transmission component 735 is capable of, configured to, or operable to support a means for transmitting the uplink shared channel message via an UL-SB of the slot according to the one or more rules, where the one or more rules indicate that the uplink shared channel occasion is valid based on the uplink shared channel occasion being within the UL-SB of a sub-band full-duplex symbol in the slot.

In some examples, the TDD configuration component 740 is capable of, configured to, or operable to support a means for receiving a time division duplex configuration for the UE, the time division duplex configuration indicating a slot format of the slot, where the one or more rules indicate that the uplink shared channel occasion is valid based on the slot format of the slot including a downlink slot format or a flexible slot format according to the time division duplex configuration.

In some examples, the TDD configuration component 740 is capable of, configured to, or operable to support a means for receiving a time division duplex configuration for the UE, the time division duplex configuration indicating a slot format of the slot, where the one or more rules indicate that the uplink shared channel occasion is valid based on the slot format of the slot including an uplink slot format or a flexible slot format according to the time division duplex configuration.

In some examples, to support transmitting the uplink shared channel message, the PUSCH transmission component 735 is capable of, configured to, or operable to support a means for transmitting the uplink shared channel message via the slot according to the one or more rules, where the one or more rules indicate that the uplink shared channel occasion is valid based on a slot format of the slot including a flexible slot format.

In some examples, to support transmitting the uplink shared channel message, the TDD configuration component 740 is capable of, configured to, or operable to support a means for transmitting the uplink shared channel message according to the one or more rules, where the one or more rules indicate that the uplink shared channel occasion is valid based on one or more frequency resources associated with the uplink shared channel occasion being different from one or more second frequency resources associated with one or more second uplink shared channel occasions that overlap in time resources in at least one symbol with the uplink shared channel occasion.

In some examples, to support transmitting the uplink shared channel message, the PUSCH transmission component 735 is capable of, configured to, or operable to support a means for transmitting the uplink shared channel message according to the one or more rules, where the one or more rules indicate that the uplink shared channel occasion is valid based on one or more time resources associated with the uplink shared channel occasion being different from one or more second time resources associated with one or more second uplink shared channel occasions.

In some examples, to support transmitting the uplink shared channel message, the PUSCH transmission component 735 is capable of, configured to, or operable to support a means for transmitting the uplink shared channel message according to the one or more rules, where the one or more rules indicate that the uplink shared channel occasion is valid based on a first set of time-frequency resources associated with the uplink shared channel occasion being different from a second set of time-frequency resources associated with one or more random access occasions.

In some examples, the one or more random access occasions are associated with the two-step random access procedure, a four-step random access procedure, or both.

In some examples, the one or more random access occasions are associated with the sub-band full-duplex configuration, a time division duplex configuration, or both.

In some examples, the one or more uplink shared channel occasions include uplink shared channel occasions dedicated for sub-band full-duplex operations.

In some examples, the one or more uplink shared channel occasions include uplink shared channel occasions associated with sub-band full-duplex operations and uplink shared channel occasions associated with time division duplex operations.

In some examples, to support transmitting the uplink shared channel message, the PUSCH transmission component 735 is capable of, configured to, or operable to support a means for transmitting the uplink shared channel message according to the one or more rules, where the one or more rules indicate that the uplink shared channel occasion is valid based on the uplink shared channel occasion beginning at least a first threshold quantity of symbols (e.g., the second threshold quantity of symbols, as described above) after a first BBB or a first broadcast channel message and beginning a second threshold quantity of symbols (e.g., the third threshold quantity of symbols, as described above) before a second BBB or a second broadcast channel message.

In some examples, to support transmitting the uplink shared channel message, the PUSCH transmission component 735 is capable of, configured to, or operable to support a means for transmitting the uplink shared channel message according to the one or more rules, where the one or more rules indicate that the uplink shared channel occasion is valid based on the uplink shared channel occasion beginning at least a threshold quantity of symbols (e.g., the first threshold quantity of symbols, as described above) after a previous downlink symbol.

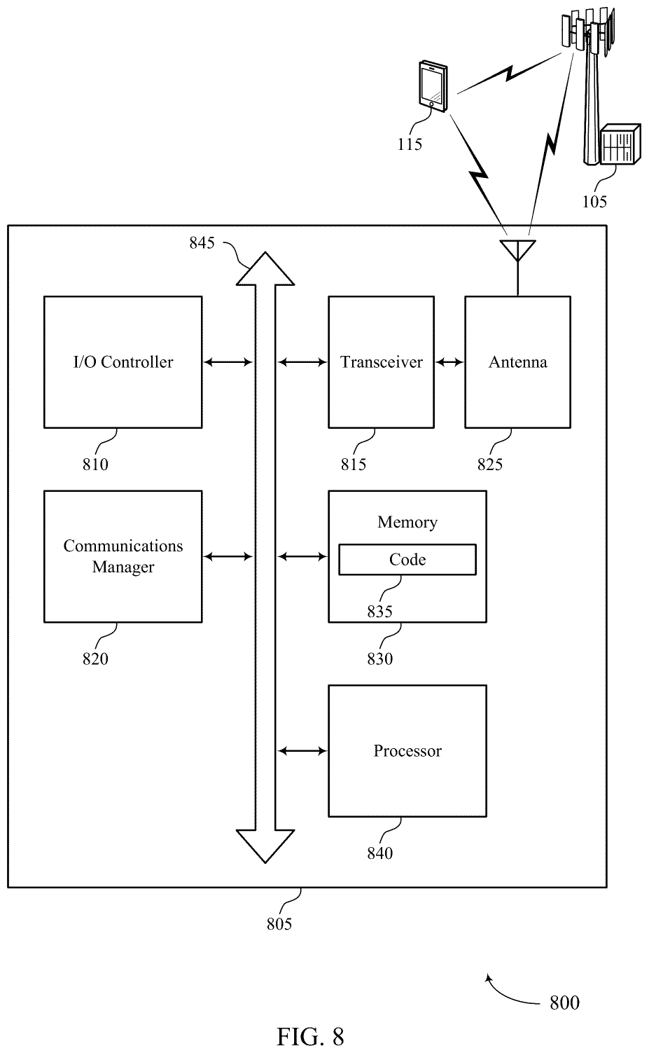

FIG. 8 shows a diagram of a system 800 including a device 805 that supports PO validation in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting PO validation). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a sub-band full-duplex configuration for the UE, the sub-band full-duplex configuration indicating one or more slots configured for sub-band full-duplex operations. The communications manager 820 is capable of, configured to, or operable to support a means for receiving a message indicating one or more uplink shared channel occasions for the UE, where at least one uplink shared channel occasion of the one or more uplink shared channel occasions is within a slot of the one or more slots configured for sub-band full-duplex operations. The communications manager 820 is capable of, configured to, or operable to support a means for transmitting, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

By including or configuring the communications manager 820 in accordance with examples as described herein, the device 805 may support techniques for reduced latency (e.g., specifically reduced latency associated with initial access and RACH procedures). For example, a UE 115 implementing the techniques described herein may validate and transmit a MsgA via a PO that is configured in an SBFD slot, or an SBFD-dedicated PO. This may reduce a waiting time between transmitting the MsgA preamble and transmitting the MsgA PUSCH, which may reduce a latency associated with the RACH procedure.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of PO validation as described herein, or the at least one processor 840 and the at least one memory 830 may be otherwise configured to, individually or collectively, perform or support such operations.

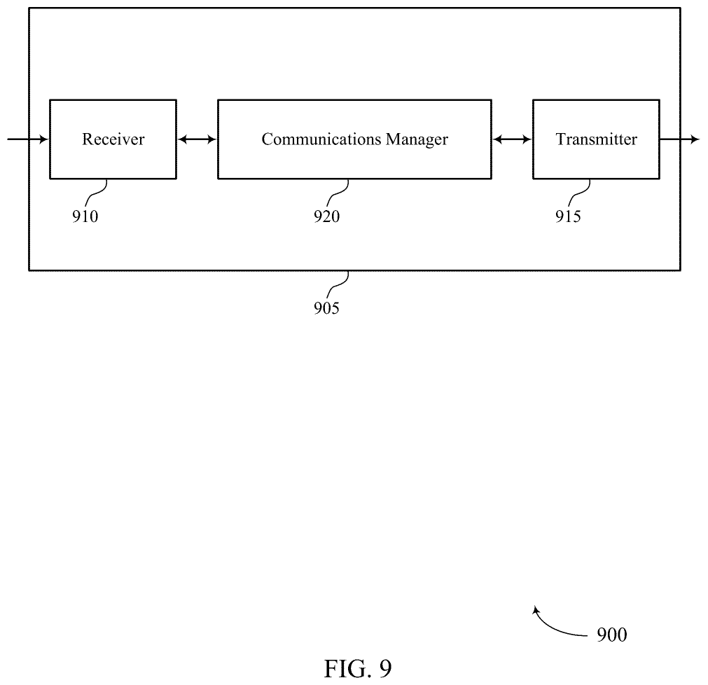

FIG. 9 shows a block diagram 900 of a device 905 that supports PO validation in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of PO validation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, a GPU, and NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a sub-band full-duplex configuration for a UE, the sub-band full-duplex configuration indicating one or more slots configured for sub-band full-duplex operations. The communications manager 920 is capable of, configured to, or operable to support a means for outputting a message indicating one or more uplink shared channel occasions for the UE, where at least one uplink shared channel occasion of the one or more uplink shared channel occasions is within a slot of the one or more slots configured for sub-band full-duplex operations. The communications manager 920 is capable of, configured to, or operable to support a means for obtaining, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources. For example, a network entity 105 implementing the techniques described herein may be capable of receiving one or more POs via valid POs of UL-SBs in SBFD slots, which may allow the network entity 105 to connect with an SBFD-aware UE without using other POs for other (e.g., legacy) UEs.

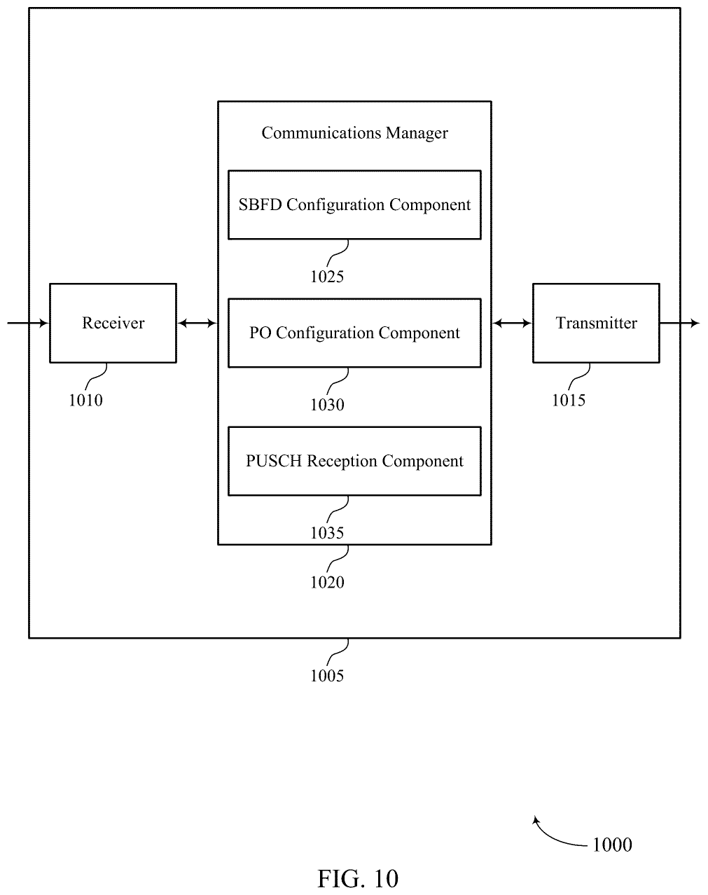

FIG. 10 shows a block diagram 1000 of a device 1005 that supports PO validation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of PO validation as described herein. For example, the communications manager 1020 may include an SBFD configuration component 1025, a PO configuration component 1030, an PUSCH reception component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The SBFD configuration component 1025 is capable of, configured to, or operable to support a means for outputting a sub-band full-duplex configuration for a UE, the sub-band full-duplex configuration indicating one or more slots configured for sub-band full-duplex operations. The PO configuration component 1030 is capable of, configured to, or operable to support a means for outputting a message indicating one or more uplink shared channel occasions for the UE, where at least one uplink shared channel occasion of the one or more uplink shared channel occasions is within a slot of the one or more slots configured for sub-band full-duplex operations. The PUSCH reception component 1035 is capable of, configured to, or operable to support a means for obtaining, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

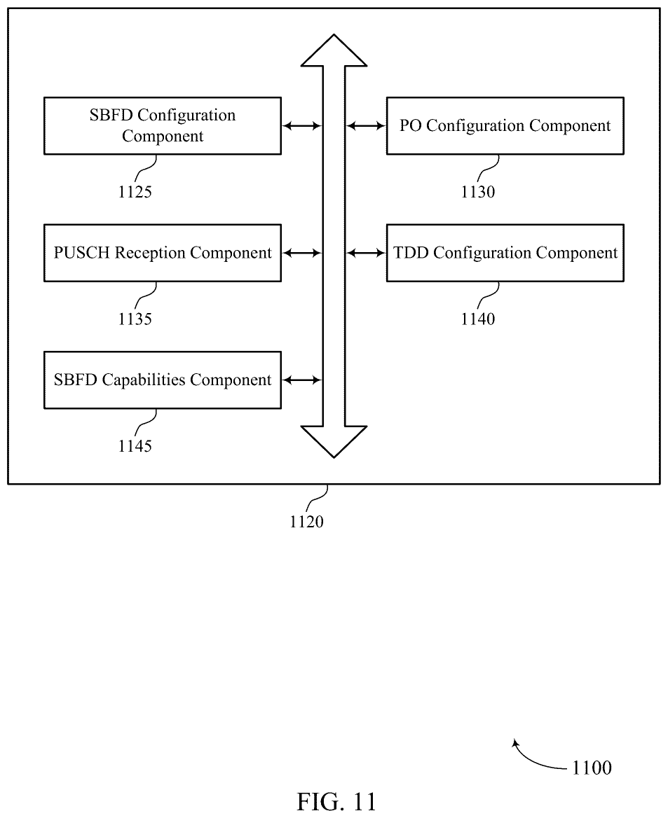

FIG. 11 shows a block diagram 1100 of a communications manager 1120 that supports PO validation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of PO validation as described herein. For example, the communications manager 1120 may include an SBFD configuration component 1125, a PO configuration component 1130, an PUSCH reception component 1135, a TDD configuration component 1140, an SBFD capabilities component 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The SBFD configuration component 1125 is capable of, configured to, or operable to support a means for outputting a sub-band full-duplex configuration for a UE, the sub-band full-duplex configuration indicating one or more slots configured for sub-band full-duplex operations. The PO configuration component 1130 is capable of, configured to, or operable to support a means for outputting a message indicating one or more uplink shared channel occasions for the UE, where at least one uplink shared channel occasion of the one or more uplink shared channel occasions is within a slot of the one or more slots configured for sub-band full-duplex operations. The PUSCH reception component 1135 is capable of, configured to, or operable to support a means for obtaining, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

In some examples, to support obtaining the uplink shared channel message, the PUSCH reception component 1135 is capable of, configured to, or operable to support a means for obtaining the uplink shared channel message via an UL-SB of the slot according to the one or more rules, where the one or more rules indicate that the uplink shared channel occasion is valid based on the uplink shared channel occasion being within the UL-SB of a sub-band full-duplex symbol on the slot.

In some examples, the TDD configuration component 1140 is capable of, configured to, or operable to support a means for outputting a time division duplex configuration to the UE, the time division duplex configuration indicating a slot format of the slot, where the one or more rules indicate that the uplink shared channel occasion is valid based on the slot format of the slot including a downlink slot format or a flexible slot format according to the time division duplex configuration.

In some examples, the TDD configuration component 1140 is capable of, configured to, or operable to support a means for outputting a time division duplex configuration to the UE, the time division duplex configuration indicating a slot format of the slot, where the one or more rules indicate that the uplink shared channel occasion is valid based on the slot format of the slot including an uplink slot format or a flexible slot format according to the time division duplex configuration.

In some examples, to support obtaining the uplink shared channel message, the PUSCH reception component 1135 is capable of, configured to, or operable to support a means for obtaining the uplink shared channel message via the slot according to the one or more rules, where the one or more rules indicate that the uplink shared channel occasion is valid based on a slot format of the slot including a flexible slot format.

In some examples, to support obtaining the uplink shared channel message, the PUSCH reception component 1135 is capable of, configured to, or operable to support a means for obtaining the uplink shared channel message according to the one or more rules, where the one or more rules indicate that the uplink shared channel occasion is valid based on one or more frequency resources associated with the uplink shared channel occasion being different from one or more second frequency resources associated with one or more second uplink shared channel occasions.

In some examples, to support obtaining the uplink shared channel message, the PUSCH reception component 1135 is capable of, configured to, or operable to support a means for obtaining the uplink shared channel message according to the one or more rules, where the one or more rules indicate that the uplink shared channel occasion is valid based on one or more time resources associated with the uplink shared channel occasion being different from one or more second time resources associated with one or more second uplink shared channel occasions.

In some examples, to support obtaining the uplink shared channel message, the PUSCH reception component 1135 is capable of, configured to, or operable to support a means for obtaining the uplink shared channel message according to the one or more rules, where the one or more rules indicate that the uplink shared channel occasion is valid based on a first set of time-frequency resources associated with the uplink shared channel occasion being different from a second set of time-frequency resources associated with one or more random access occasions.

In some examples, the one or more random access occasions are associated with the two-step random access procedure, a four-step random access procedure, or both.

In some examples, the one or more random access occasions are associated with the sub-band full-duplex configuration, a time division duplex configuration, or both.

In some examples, the one or more uplink shared channel occasions include uplink shared channel occasions dedicated for sub-band full-duplex operations.

In some examples, to support obtaining the uplink shared channel message, the PUSCH reception component 1135 is capable of, configured to, or operable to support a means for obtaining the uplink shared channel message according to the one or more rules, where the one or more rules indicate that the uplink shared channel occasion is valid based on the uplink shared channel occasion beginning at least a first threshold quantity of symbols after a first BBB or a first broadcast channel message and beginning a second threshold quantity of symbols before a second BBB or second broadcast channel message.

In some examples, to support obtaining the uplink shared channel message, the PUSCH reception component 1135 is capable of, configured to, or operable to support a means for obtaining the uplink shared channel message according to the one or more rules, where the one or more rules indicate that the uplink shared channel occasion is valid based on the uplink shared channel occasion beginning at least a threshold quantity of symbols after a previous downlink symbol.

In some examples, the SBFD capabilities component 1145 is capable of, configured to, or operable to support a means for obtaining, from the UE, an indication of a sub-band full-duplex capability of the UE.

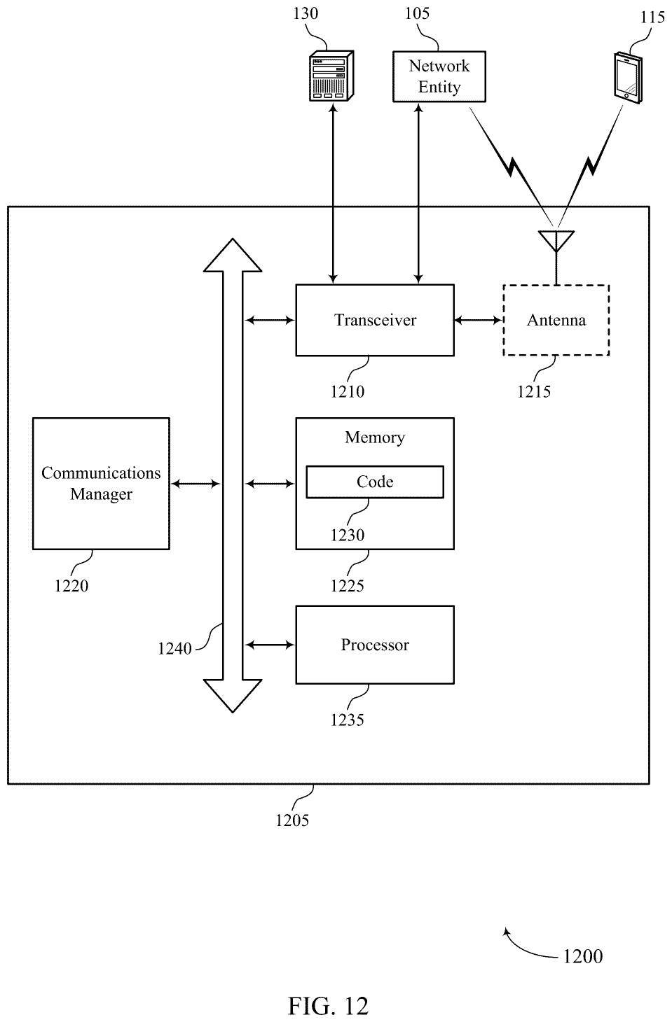

FIG. 12 shows a diagram of a system 1200 including a device 1205 that supports PO validation in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting PO validation). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network devices 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a sub-band full-duplex configuration for a UE, the sub-band full-duplex configuration indicating one or more slots configured for sub-band full-duplex operations. The communications manager 1220 is capable of, configured to, or operable to support a means for outputting a message indicating one or more uplink shared channel occasions for the UE, where at least one uplink shared channel occasion of the one or more uplink shared channel occasions is within a slot of the one or more slots configured for sub-band full-duplex operations. The communications manager 1220 is capable of, configured to, or operable to support a means for obtaining, via an uplink shared channel occasion of the one or more uplink shared channel occasions based on a validity of the uplink shared channel occasion, an uplink shared channel message including at least a portion of a first random access message associated with a two-step random access procedure, where the validity of the uplink shared channel occasion is based on one or more rules associated with the sub-band full-duplex configuration.

By including or configuring the communications manager 1220 in accordance with examples as described herein, the device 1205 may support techniques for reduced latency (e.g., specifically reduced latency associated with initial access and RACH procedures). For example, a network entity 105 implementing the techniques described herein may validate and receive a MsgA via a PO that is configured in an SBFD slot, or an SBFD-dedicated PO. This may reduce a waiting time between receiving the MsgA preamble and receiving the MsgA PUSCH, which may reduce a latency associated with the RACH procedure.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of PO validation as described herein, or the at least one processor 1235 and the at least one memory 1225 may be otherwise configured to, individually or collectively, perform or support such operations.

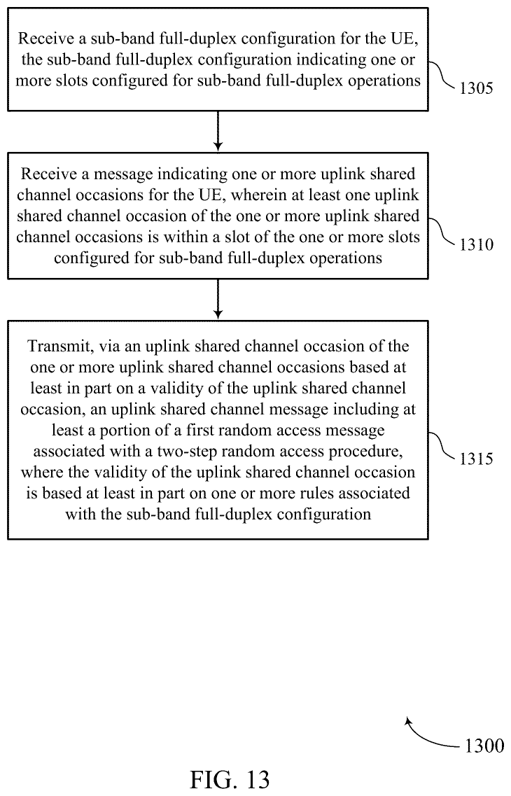

FIG. 13 shows a flowchart illustrating a method 1300 that supports PO validation in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a sub-band full-duplex configuration for the UE, the sub-band full-duplex configuration indicating one or more slots configured for sub-band full-duplex operations. The operations of 1305 may be performed in accordance with examples as disclosed herein. In some examples, aspects of the operations of 1305 may be performed by an SBFD configuration component 725 as described with reference to FIG. 7.

At 1310, the method may include receiving a message indicating one or more uplink shared channel occasions for the UE, wherein at least one uplink shared channel occasion of the one or more uplink shared channel occasions is within a slot of the one or more slots configured for sub-band full-duplex operations. The operations of 1310 may be performed in accordance with examples as disclosed herein. In some examples, aspects of the operations of 1310 may be performed by a PO configuration component 730 as described with reference to FIG. 7.

At 1315, the method may include transmitting, via an uplink shared channel occasion of the one or more uplink shared channel occasions based at least in part on a validity of the uplink shared channel occasion, an uplink shared channel message including at least a portion of a first random access message associated with a two-step random access procedure, where the validity of the uplink shared channel occasion is based at least in part on one or more rules associated with the sub-band full-duplex configuration. The operations of 1315 may be performed in accordance with examples as disclosed herein. In some examples, aspects of the operations of 1315 may be performed by an PUSCH transmission component 735 as described with reference to FIG. 7.

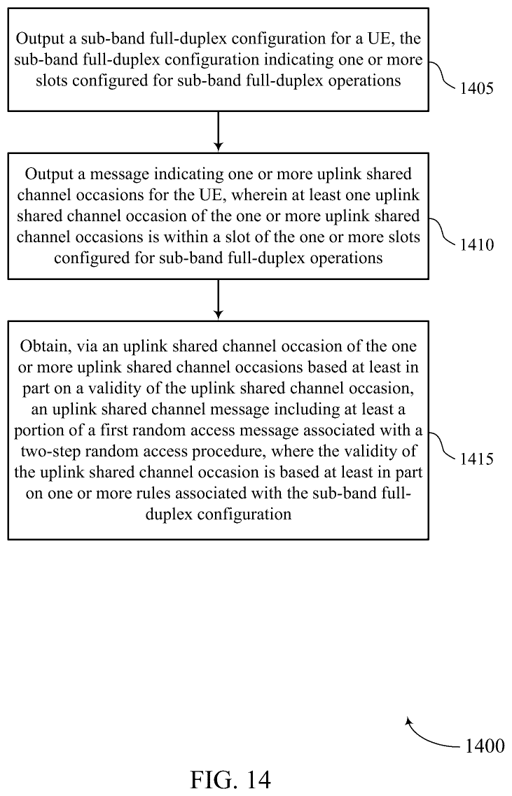

FIG. 14 shows a flowchart illustrating a method 1400 that supports PO validation in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting a sub-band full-duplex configuration for a UE, the sub-band full-duplex configuration indicating one or more slots configured for sub-band full-duplex operations. The operations of 1405 may be performed in accordance with examples as disclosed herein. In some examples, aspects of the operations of 1405 may be performed by an SBFD configuration component 1125 as described with reference to FIG. 11.

At 1410, the method may include outputting a message indicating one or more uplink shared channel occasions for the UE, wherein at least one uplink shared channel occasion of the one or more uplink shared channel occasions is within a slot of the one or more slots configured for sub-band full-duplex operations. The operations of 1410 may be performed in accordance with examples as disclosed herein. In some examples, aspects of the operations of 1410 may be performed by a PO configuration component 1130 as described with reference to FIG. 11.

At 1415, the method may include obtaining, via an uplink shared channel occasion of the one or more uplink shared channel occasions based at least in part on a validity of the uplink shared channel occasion, an uplink shared channel message including at least a portion of a first random access message associated with a two-step random access procedure, where the validity of the uplink shared channel occasion is based at least in part on one or more rules associated with the sub-band full-duplex configuration. The operations of 1415 may be performed in accordance with examples as disclosed herein. In some examples, aspects of the operations of 1415 may be performed by an PUSCH reception component 1135 as described with reference to FIG. 11.

The following provides an overview of aspects of the present disclosure:

Aspect 1: A method for wireless communications at a UE, comprising: receiving a SBFD configuration for the UE, the SBFD configuration indicating one or more slots configured for SBFD operations; receiving a message indicating one or more POs for the UE, wherein at least one PO of the one or more POs is within a slot of the one or more slots configured for SBFD operations; and transmitting, via an PO of the one or more POs based at least in part on a validity of the PO, an uplink shared channel message comprising at least a portion of a first RA message associated with a two-step RACH procedure, wherein the validity of the PO is based at least in part on one or more rules associated with the SBFD configuration.

Aspect 2: The method of aspect 1, wherein the at least one PO comprises the PO, and wherein transmitting the uplink shared channel message comprises: transmitting the uplink shared channel message via an UL-SB of the slot according to the one or more rules, wherein the one or more rules indicate that the PO is valid based at least in part on the PO being within the UL-SB of a SBFD symbol in the slot.

Aspect 3: The method of aspect 2, further comprising: receiving a TDD configuration for the UE, the TDD configuration indicating a slot format of the slot, wherein the one or more rules indicate that the PO is valid based at least in part on the slot format of the slot comprising a downlink slot format or a flexible slot format according to the TDD configuration.

Aspect 4: The method of any of aspects 1 through 3, further comprising: receiving a TDD configuration for the UE, the TDD configuration indicating a slot format of the slot, wherein the one or more rules indicate that the PO is valid based at least in part on the slot format of the slot comprising an uplink slot format or a flexible slot format according to the TDD configuration.

Aspect 5: The method of any of aspects 1 through 4, wherein transmitting the uplink shared channel message comprises: transmitting the uplink shared channel message via the slot according to the one or more rules, wherein the one or more rules indicate that the PO is valid based at least in part on a slot format of the slot comprising a flexible slot format.

Aspect 6: The method of any of aspects 1 through 5, wherein transmitting the uplink shared channel message comprises: transmitting the uplink shared channel message according to the one or more rules, wherein the one or more rules indicate that the PO is valid based at least in part on one or more frequency resources associated with the PO being different from one or more second frequency resources associated with one or more second POs that overlap in time resources in at least one symbol with the PO.

Aspect 7: The method of any of aspects 1 through 6, wherein transmitting the uplink shared channel message comprises: transmitting the uplink shared channel message according to the one or more rules, wherein the one or more rules indicate that the PO is valid based at least in part on one or more time resources associated with the PO being different from one or more second time resources associated with one or more second POs.

Aspect 8: The method of any of aspects 1 through 7, wherein transmitting the uplink shared channel message comprises: transmitting the uplink shared channel message according to the one or more rules, wherein the one or more rules indicate that the PO is valid based at least in part on a first set of time-frequency resources associated with the PO being different from a second set of time-frequency resources associated with one or more ROs.

Aspect 9: The method of aspect 8, wherein the one or more ROs are associated with the two-step RACH procedure, a four-step RACH procedure, or both.

Aspect 10: The method of any of aspects 8 through 9, wherein the one or more ROs are associated with the SBFD configuration, a TDD configuration, or both.

Aspect 11: The method of any of aspects 1 through 10, wherein the one or more POs comprise POs dedicated for SBFD operations.

Aspect 12: The method of any of aspects 1 through 11, wherein the one or more POs comprise POs associated with SBFD operations and POs associated with TDD operations.

Aspect 13: The method of any of aspects 1 through 12, wherein transmitting the uplink shared channel message comprises: transmitting the uplink shared channel message according to the one or more rules, wherein the one or more rules indicate that the PO is valid based at least in part on the PO beginning at least a first threshold quantity of symbols after a first SSB or a first broadcast channel message (e.g., PBCH block) and beginning a second threshold quantity of symbols before a second SSB or a second broadcast channel message.

Aspect 14: The method of any of aspects 1 through 13, wherein transmitting the uplink shared channel message comprises: transmitting the uplink shared channel message according to the one or more rules, wherein the one or more rules indicate that the PO is valid based at least in part on the PO beginning at least a threshold quantity of symbols after a previous downlink symbol.

Aspect 15: A method for wireless communications at a network entity, comprising: outputting a SBFD configuration for a UE, the SBFD configuration indicating one or more slots configured for SBFD operations; outputting a message indicating one or more POs for the UE, wherein at least one PO of the one or more POs is within a slot of the one or more slots configured for SBFD operations; and obtaining, via an PO of the one or more POs based at least in part on a validity of the PO, an uplink shared channel message comprising at least a portion of a first RA message associated with a two-step RACH procedure, wherein the validity of the PO is based at least in part on one or more rules associated with the SBFD configuration.

Aspect 16: The method of aspect 15, wherein the at least one PO comprises the PO, and wherein obtaining the uplink shared channel message comprises: obtaining the uplink shared channel message via an UL-SB of the slot according to the one or more rules, wherein the one or more rules indicate that the PO is valid based at least in part on the PO being within the UL-SB of a SBFD symbol on the slot.

Aspect 17: The method of aspect 16, further comprising: outputting a TDD configuration to the UE, the TDD configuration indicating a slot format of the slot, wherein the one or more rules indicate that the PO is valid based at least in part on the slot format of the slot comprising a downlink slot format or a flexible slot format according to the TDD configuration.

Aspect 18: The method of any of aspects 15 through 17, further comprising: outputting a TDD configuration to the UE, the TDD configuration indicating a slot format of the slot, wherein the one or more rules indicate that the PO is valid based at least in part on the slot format of the slot comprising an uplink slot format or a flexible slot format according to the TDD configuration.

Aspect 19: The method of any of aspects 15 through 18, wherein obtaining the uplink shared channel message comprises: obtaining the uplink shared channel message via the slot according to the one or more rules, wherein the one or more rules indicate that the PO is valid based at least in part on a slot format of the slot comprising a flexible slot format.

Aspect 20: The method of any of aspects 15 through 19, wherein obtaining the uplink shared channel message comprises: obtaining the uplink shared channel message according to the one or more rules, wherein the one or more rules indicate that the PO is valid based at least in part on one or more frequency resources associated with the PO being different from one or more second frequency resources associated with one or more second POs.

Aspect 21: The method of any of aspects 15 through 20, wherein obtaining the uplink shared channel message comprises: obtaining the uplink shared channel message according to the one or more rules, wherein the one or more rules indicate that the PO is valid based at least in part on one or more time resources associated with the PO being different from one or more second time resources associated with one or more second POs.

Aspect 22: The method of any of aspects 15 through 21, wherein obtaining the uplink shared channel message comprises: obtaining the uplink shared channel message according to the one or more rules, wherein the one or more rules indicate that the PO is valid based at least in part on a first set of time-frequency resources associated with the PO being different from a second set of time-frequency resources associated with one or more ROs.

Aspect 23: The method of aspect 22, wherein the one or more ROs are associated with the two-step RACH procedure, a four-step RACH procedure, or both.

Aspect 24: The method of any of aspects 22 through 23, wherein the one or more ROs are associated with the SBFD configuration, a TDD configuration, or both.

Aspect 25: The method of any of aspects 15 through 24, wherein the one or more POs comprise POs dedicated for SBFD operations (e.g., SBFD-dedicated POs).

Aspect 26: The method of any of aspects 15 through 25, wherein obtaining the uplink shared channel message comprises: obtaining the uplink shared channel message according to the one or more rules, wherein the one or more rules indicate that the PO is valid based at least in part on the PO beginning at least a first threshold quantity of symbols after a first SSB or a first broadcast channel message and beginning a second threshold quantity of symbols before a second SSB or second broadcast channel message.

Aspect 27: The method of any of aspects 15 through 26, wherein obtaining the uplink shared channel message comprises: obtaining the uplink shared channel message according to the one or more rules, wherein the one or more rules indicate that the PO is valid based at least in part on the PO beginning at least a threshold quantity of symbols after a previous downlink symbol.

Aspect 28: The method of any of aspects 15 through 27, further comprising: obtaining, from the UE, an indication of a SBFD capability of the UE.

Aspect 29: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by at least one processor (e.g., directly, indirectly, after pre-processing, without pre-processing) to perform a method of any of aspects 1 through 14.

Aspect 32: A network entity for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by at least one processor to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), communications manager 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a sub-band full-duplex configuration for the UE, the sub-band full-duplex configuration indicating one or more slots configured for sub-band full-duplex operations;
receive a message indicating one or more uplink shared channel occasions for the UE, wherein at least one uplink shared channel occasion of the one or more uplink shared channel occasions is within a slot of the one or more slots configured for sub-band full-duplex operations; and
transmit, via an uplink shared channel occasion of the one or more uplink shared channel occasions based at least in part on a validity of the uplink shared channel occasion, an uplink shared channel message comprising at least a portion of a first random access message associated with a two-step random access procedure, wherein the validity of the uplink shared channel occasion is based at least in part on one or more rules associated with the sub-band full-duplex configuration.

2. The UE of claim 1, wherein, to transmit the uplink shared channel message, the one or more processors are individually or collectively operable to execute the code to cause the UE to:
transmit the uplink shared channel message via an uplink sub-band of the slot according to the one or more rules, wherein the one or more rules indicate that the uplink shared channel occasion is valid based at least in part on the uplink shared channel occasion being within the uplink sub-band of a sub-band full-duplex symbol on the slot.

3. The UE of claim 2, wherein the one or more processors are individually or collectively further operable to execute the code to cause the UE to:
receive a time division duplex configuration for the UE, the time division duplex configuration indicating a slot format of the slot, wherein the one or more rules indicate that the uplink shared channel occasion is valid based at least in part on the slot format of the slot comprising a downlink slot format or a flexible slot format according to the time division duplex configuration.

4. The UE of claim 1, wherein, to transmit the uplink shared channel message, the one or more processors are individually or collectively operable to execute the code to cause the UE to:
transmit the uplink shared channel message according to the one or more rules, wherein the one or more rules indicate that the uplink shared channel occasion is valid based at least in part on the uplink shared channel occasion beginning at least a first threshold quantity of symbols after a first synchronization signal block or a first broadcast channel message and beginning a second threshold quantity of symbols before a second synchronization signal block or a second broadcast channel message.

5. The UE of claim 1, wherein, to transmit the uplink shared channel message, the one or more processors are individually or collectively operable to execute the code to cause the UE to:
transmit the uplink shared channel message according to the one or more rules, wherein the one or more rules indicate that the uplink shared channel occasion is valid based at least in part on one or more time resources associated with the uplink shared channel occasion being different from one or more second time resources associated with one or more second uplink shared channel occasions.

6. The UE of claim 1, wherein, to transmit the uplink shared channel message, the one or more processors are individually or collectively operable to execute the code to cause the UE to:
transmit the uplink shared channel message according to the one or more rules, wherein the one or more rules indicate that the uplink shared channel occasion is valid based at least in part on a first set of time-frequency resources associated with the uplink shared channel occasion being different from a second set of time-frequency resources associated with one or more random access occasions.

7. The UE of claim 6, wherein the one or more random access occasions are associated with the two-step random access procedure, a four-step random access procedure, or both.

8. The UE of claim 6, wherein the one or more random access occasions are associated with the sub-band full-duplex configuration, a time division duplex configuration, or both.

9. The UE of claim 1, wherein the one or more uplink shared channel occasions comprise uplink shared channel occasions dedicated for sub-band full-duplex operations.

10. The UE of claim 1, wherein, to transmit the uplink shared channel message, the one or more processors are individually or collectively operable to execute the code to cause the UE to:
transmit the uplink shared channel message according to the one or more rules, wherein the one or more rules indicate that the uplink shared channel occasion is valid based at least in part on the uplink shared channel occasion beginning at least a first threshold quantity of symbols after a first synchronization signal block or a first broadcast channel message and beginning a second threshold quantity of symbols before a second synchronization signal block or a second broadcast channel message.

11. The UE of claim 1, wherein, to transmit the uplink shared channel message, the one or more processors are individually or collectively operable to execute the code to cause the UE to:
transmit the uplink shared channel message according to the one or more rules, wherein the one or more rules indicate that the uplink shared channel occasion is valid based at least in part on the uplink shared channel occasion beginning at least a threshold quantity of symbols after a previous downlink symbol.

12. The UE of claim 1, wherein the one or more processors are individually or collectively further operable to execute the code to cause the UE to:
receive a time division duplex configuration for the UE, the time division duplex configuration indicating a slot format of the slot, wherein the one or more rules indicate that the uplink shared channel occasion is valid based at least in part on the slot format of the slot comprising an uplink slot format or a flexible slot format according to the time division duplex configuration.

13. The UE of claim 1, wherein, to transmit the uplink shared channel message, the one or more processors are individually or collectively operable to execute the code to cause the UE to:
transmit the uplink shared channel message via the slot according to the one or more rules, wherein the one or more rules indicate that the uplink shared channel occasion is valid based at least in part on a slot format of the slot comprising a flexible slot format.

14. The UE of claim 1, wherein, to transmit the uplink shared channel message, the one or more processors are individually or collectively operable to execute the code to cause the UE to:
transmit the uplink shared channel message according to the one or more rules, wherein the one or more rules indicate that the uplink shared channel occasion is valid based at least in part on one or more frequency resources associated with the uplink shared channel occasion being different from one or more second frequency resources associated with one or more second uplink shared channel occasions.

15. A network entity, comprising:
one or more memories storing processor-executable code; and
one or more processors coupled with the one or more memories and individually or collectively operable to execute the code to cause the network entity to:
output a sub-band full-duplex configuration for a UE, the sub-band full-duplex configuration indicating one or more slots configured for sub-band full-duplex operations;
output a message indicating one or more uplink shared channel occasions for the UE, wherein at least one uplink shared channel occasion of the one or more uplink shared channel occasions is within a slot of the one or more slots configured for sub-band full-duplex operations; and
obtain, via an uplink shared channel occasion of the one or more uplink shared channel occasions based at least in part on a validity of the uplink shared channel occasion, an uplink shared channel message comprising at least a portion of a first random access message associated with a two-step random access procedure, wherein the validity of the uplink shared channel occasion is based at least in part on one or more rules associated with the sub-band full-duplex configuration.

16. The network entity of claim 15, wherein, to obtain the uplink shared channel message, the one or more processors are individually or collectively operable to execute the code to cause the network entity to:
obtain the uplink shared channel message via an uplink sub-band of the slot according to the one or more rules, wherein the one or more rules indicate that the uplink shared channel occasion is valid based at least in part on the uplink shared channel occasion being within the uplink sub-band of a sub-band full-duplex symbol on the slot.

17. The network entity of claim 16, wherein the one or more processors are individually or collectively further operable to execute the code to cause the network entity to:
output a time division duplex configuration to the UE, the time division duplex configuration indicating a slot format of the slot, wherein the one or more rules indicate that the uplink shared channel occasion is valid based at least in part on the slot format of the slot comprising a downlink slot format or a flexible slot format according to the time division duplex configuration.

18. The network entity of claim 15, wherein, to obtain the uplink shared channel message, the one or more processors are individually or collectively operable to execute the code to cause the network entity to:
obtain the uplink shared channel message according to the one or more rules, wherein the one or more rules indicate that the uplink shared channel occasion is valid based at least in part on the uplink shared channel occasion beginning at least a first threshold quantity of symbols after a first synchronization signal block or a first broadcast channel message and beginning a second threshold quantity of symbols before a second synchronization signal block or second broadcast channel message.

19. The network entity of claim 15, wherein, to obtain the uplink shared channel message, the one or more processors are individually or collectively operable to execute the code to cause the network entity to:
obtain the uplink shared channel message according to the one or more rules, wherein the one or more rules indicate that the uplink shared channel occasion is valid based at least in part on one or more time resources associated with the uplink shared channel occasion being different from one or more second time resources associated with one or more second uplink shared channel occasions.

20. A method for wireless communications at a user equipment (UE), comprising:
receiving a sub-band full-duplex configuration for the UE, the sub-band full-duplex configuration indicating one or more slots configured for sub-band full-duplex operations;
receiving a message indicating one or more uplink shared channel occasions for the UE, wherein at least one uplink shared channel occasion of the one or more uplink shared channel occasions is within a slot of the one or more slots configured for sub-band full-duplex operations; and
transmitting, via an uplink shared channel occasion of the one or more uplink shared channel occasions based at least in part on a validity of the uplink shared channel occasion, an uplink shared channel message comprising at least a portion of a first random access message associated with a two-step random access procedure, wherein the validity of the uplink shared channel occasion is based at least in part on one or more rules associated with the sub-band full-duplex configuration.
